(19) United States
(12) Patent Application Publication
(10) Pub. No.: US 2011/0107335 A1
(43) Pub. Date: May 5, 2011

(54) METHOD AND APPARATUS FOR ESTIMATING A TASK PROCESS STRUCTURE

(75) Inventor: Katsuhisa NAKAZATO, Kawasaki (JP)

(73) Assignee: FUJITSU LIMITED, Kawasaki-shi (JP)

(21) Appl. No.: 12/917,874

(22) Filed: Nov. 2, 2010

(30) Foreign Application Priority Data
Nov. 5, 2009 (JP) 2009-253650

(51) Int. Cl. G06F 9/46

(52) U.S. Cl. 718/100

(57) ABSTRACT

A process-structure estimating method, includes counting a number of the events executed in parallel and are added-numbers; generating virtual route data including a start point and an end point for the events for which no added-number attribute is set, a branch point coupled to the start point and branched into branch routes for corresponding pairs of the added-number attributes and the attribute values of the added-number attributes, and a merge point at which the branch routes are merged together, the merge point being coupled to the end point; determining, the branch route on which the added-number-attribute-set event is to be placed on the virtual route data based on the added-number attributes, values thereof, processing times associated therewith, and updating the virtual route data based on the branch route.

### CROSS-REFERENCE TO RELATED APPLICATIONS

This application is based upon and claims the benefit of priority of the prior Japanese Patent Application No. 2009-253650, filed on Nov. 5, 2009, the entire contents of which are incorporated herein by reference.

### FIELD

The embodiments discussed herein relate to a task-process analyzing technology.

### BACKGROUND

A technology for extracting a series of associated task events from processing records stored in a database in a task system and visualizing the series of task events as a group of a task processes in a flow diagram is available in order task process visualization.

Data of a series of tasks executed for respective cases are extracted from a database in which results of task processing are stored, and process instances in which the names and times of the tasks executed for the respective cases are time-sequentially arranged are generated. Of the process instances, process instances that satisfy a specified condition are classified, and an average value and a standard deviation of transition times, each indicating a difference between task start time and task end time, are determined with respect to a task section to be determined in the corresponding process instances. A process instance that is correlated with a route before the task section to be determined and that is excepted to be reduced in the transmission time and a process instance that is correlated with all routes and that is expected to be reduced in the transition time are specified based on the average value and the standard deviation of the transition times, and candidates for improvement are automatically presented to a user (e.g., International Patent Publication No. WO2009/098766).

### SUMMARY

According to an aspect of the invention, a process-structure estimating method, includes: counting a number of initial attributes that are set for events executed in a task system and added-number attributes that are set for each of the events executed in parallel and are added-numbers; generating virtual route data including a start point and an end point for the events for which no added-number attribute is set, a branch point coupled to the start point and branched into branch routes for corresponding pairs of the added-number attributes and the attribute values of the added-number attributes, and a merge point at which the branch routes are merged together, the merge point being coupled to the end point; determining, in ascending order of the number of added-number attributes of the events for which the at least one added-number attribute is set, the branch route on which the added-number-attribute-set event is to be placed on the virtual route data based on the added-number attributes, values thereof, processing times associated therewith, and a rule and updating the virtual route data based on the branch route.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a first example of a flow of a series of task processing including tasks executed in parallel;

FIG. 2 illustrates a collection of processing records in the series of task processing illustrated in FIG. 1;

FIG. 3 illustrates a second example of a flow of a series of task processing including tasks executed in parallel;

FIG. 4 illustrates a collection of processing records in the series of task processing illustrated in FIG. 3;

FIG. 5 illustrates an underlying technology;

FIG. 6 illustrates a task process structure estimated by the underlying technology;

FIG. 7 illustrates a problem of the underlying technology;

FIG. 8 illustrates one example of an insignificant estimation result;

FIG. 9 illustrates a specific example of added-number attributes;

FIG. 10 illustrates a specific example of the added-number attributes;

FIG. 11 is a schematic diagram of a system according to one embodiment of a present technology;

FIG. 12 is a functional block diagram of a process-structure estimating apparatus according to the present embodiment;

FIG. 13 illustrates one example of an added-number-attribute-count table stored in the added-number-attribute-count table storage unit;

FIGS. 14A to 14C illustrate a main processing flow of the process-structure estimating apparatus;

FIG. 15 illustrates processing for generating a flow instance;

FIG. 16 illustrates one example of the flow instance;

FIG. 17 illustrates one example of the flow instance;

FIG. 18 illustrates a virtual route data generated based on the flow instance illustrated in FIG. 17;

FIG. 19 illustrates a brief detail of event placement processing;

FIG. 20 illustrates a brief detail of the event placement processing;

FIG. 21 illustrates a brief detail of the event placement processing;

FIG. 22 illustrates ranges in which the added-number values on the virtual route data are valid and ranges in which the order of events is maintained;

FIGS. 23A and 23B illustrate a processing flow of the event placement processing;

FIG. 24 illustrates one example of an added-number management table;

FIG. 25 illustrates one example of map data;

FIG. 26 illustrates one example of the map data;

FIG. 27 illustrates an estimation result when a scheme according to the present embodiment is used to estimate a task process structure;

FIG. 28 illustrates one example of virtual route data for a first section;

FIG. 29 illustrates one example of virtual route data after events whose added-number attribute counts are 1 are placed on the virtual route data illustrated in FIG. 28;

FIG. 30 illustrates one example of virtual route data after events whose added-number attribute counts are 2 are placed on the virtual route data illustrated in FIG. 29;

FIG. 31 illustrates one example of virtual route data for a second section;

FIG. 32 illustrates virtual route data after events whose added-number attribute counts are 1 are placed on the virtual route data illustrated in FIG. 31;

FIG. 33 illustrates virtual route data after events whose added-number attribute counts are 2 are placed on the virtual route data illustrated in FIG. 32;

FIG. 34 illustrates virtual route data after events whose added-number attribute counts are 3 are placed on the virtual route data illustrated in FIG. 33;

FIG. 35 is an example in which the virtual route data illustrated in FIG. 30 and the virtual route data illustrated in FIG. 34 are coupled to each other;

FIG. 36 is a functional block diagram of a computer;

FIG. 37 illustrates a processing flow of a process-structure estimating method according to a first embodiment of the present technology; and

FIG. 38 is a functional block diagram of a process-structure estimating apparatus according to a second embodiment of the present technology.

### DESCRIPTION OF EMBODIMENTS

The following schemes are available as schemes for estimating a task process structure. For example, a first scheme is to estimate a task process structure on the basis of an order of event appearance. A second scheme is to estimate a task process structure by determining a match of times of event processing, for example. These schemes, however, have some problems.

Specifically, in a first scheme, it may be required that the order of appearance be highly specific. When exceptional processing (e.g., processing whose result does not facilitate an intended order of appearance) occurs to cause mixing of data irrelevant to the intended order of appearance, an erroneous structure can be derived. The probability that data mixing occurs is relatively high with actual data, because of factors such as a difference in time between serves in a task system, for example. When an attempt is made to reduce an influence of data, a result of the estimation may change greatly depending on, for example, the setting of a threshold and the reliability of the result of the estimation declines.

In a second scheme, processing times are recorded at two points in time, e.g., a processing start point and a processing end point of an event. A technology for estimating a processing time even for recording of processing time at one point is available. The technology, however, is based on the premise that the processing times of events are distributed according to a normal distribution. In addition, although events whose processing times match each other can be determined as events executed in parallel, there are also cases in which events are executed in parallel even though the processing times thereof do not match each other. The second scheme does not deal with these cases.

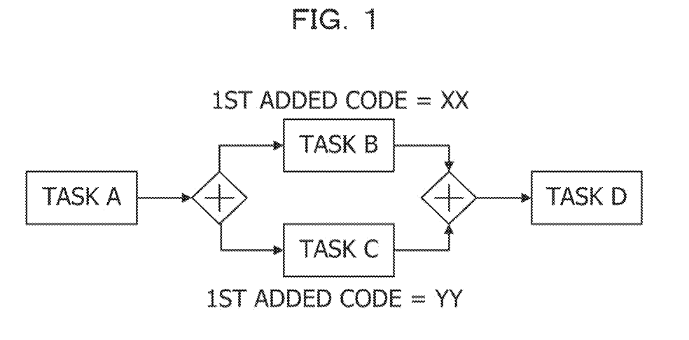

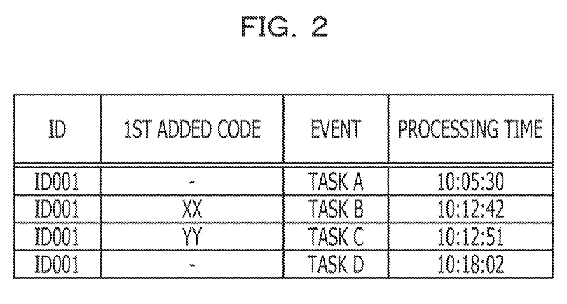

There is also a task system in which, as illustrated in FIG. 1, the values of a certain attribute are issued as added-numbers to task events executed in parallel (events B and C in the case of FIG. 1). In FIG. 1, after a task A is executed, the route is branched into a route for the task B and a route for the task C, and a first added-number of XX and a first added-number of YY are set for the task B and the task C, respectively. Then, after the route for the task B and the route for the task C are merged together, a task D is executed. In this case, data as illustrated in FIG. 2 are stored in a database in the task system. In FIG. 2, an ID (identifier) corresponds to, for example, a slip number in an order system, and events with the same ID indicates that they are a series of tasks for the same case. The first added-number in FIG. 2 corresponds to, for example, a slip detail number in the order system. Since the tasks A and D are not task events executed in parallel, the value of the first added-number is not set therefor. To which items the “ID” and the “first added-number” illustrated in FIG. 2 correspond differ depending on the individual task system.

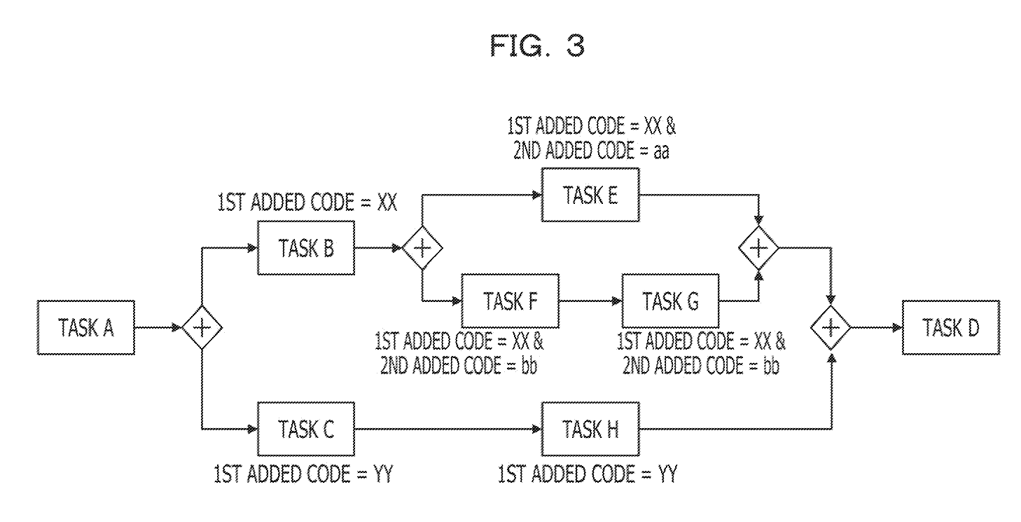

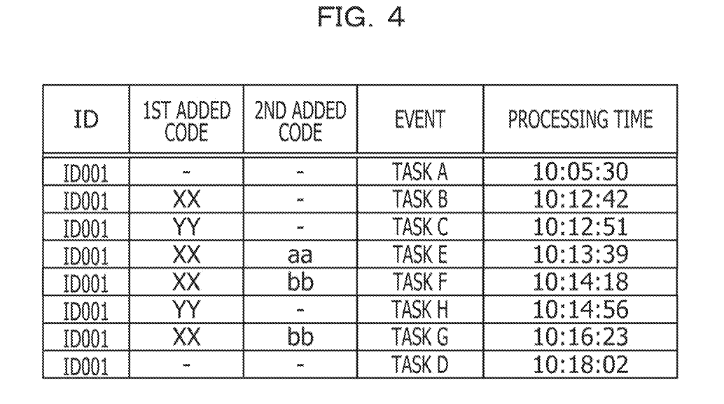

As illustrated in FIG. 3, a branched route may be branched again. In this case, values of multiple attributes are set as added-numbers. In the example of FIG. 3, after a task A is executed, the route is branched into a route for a task B and a route for a task C, and a first added-number of XX and a first added-number of YY are set for the task B and the task C, respectively. The example up to this point is substantially the same as the example illustrated in FIG. 1, but in the example of FIG. 3, the route for the task B is re-branched into a route for a task E and a route for tasks F and G. A second added-number of aa is set for the task E and a second added-number of bb is set for the tasks F and G. In the example of FIG. 3, after the task C is executed, a task H is executed on the same route and a first added-number of YY is also set for the task H. After the route into which the route for the task E and the route for the tasks F and G merge together and the route for the tasks C and H merge together, a task D is executed. In this case, data as illustrated in FIG. 4 are stored in the database in the task system. In the example of FIG. 4, the values of the second added-number are further stored.

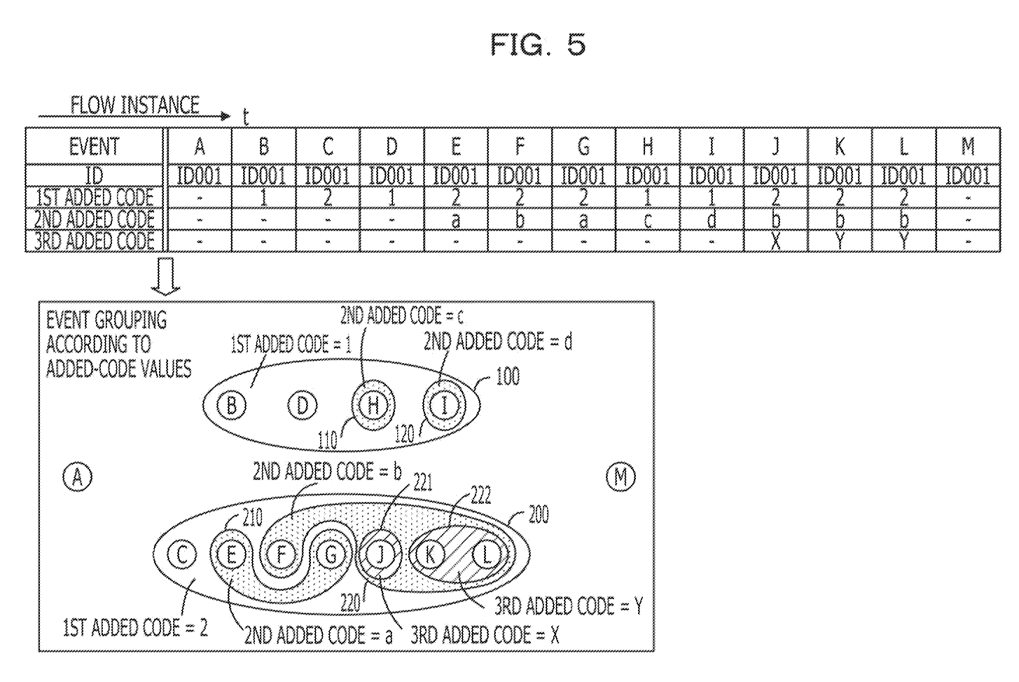

For example, there is a scheme for estimating a task process structure by using data of a series of task processing, the data being gathered from a task system that issues attribute values of a certain attribute as added-numbers to tasks events executed in parallel. One specific method for this scheme is to divide events into groups according to the added-numbers and to estimate a task process structure on the basis of the groups, as illustrated in FIG. 5. The data in the tabular form illustrated at the upper part of FIG. 5 is one example of data of a series of task processing, the data being gathered from the task system. In the present embodiment, a collection of data of a series of task processing will be referred to as a “flow instance”. In the flow instance illustrated in FIG. 5, it is assumed that events A to M are time-sequentially arranged from left to right and the time at which the event A occurs is the earliest. In the flow instance illustrated in FIG. 5, the events A to M have the same ID001, which indicates that the events A to M are a series of tasks for the same case. FIG. 5 illustrates an example in which three attributes that can be regarded as added-numbers (the attributes are hereinafter referred to as “added-number attributes”) exist. What type of attribute corresponds to the added-number varies depending on the individual task system. In FIG. 5, for convenience of description, a first added-number attribute, a second added-number attribute, and a third added-number attribute are indicated by a first added-number (or first added code), a second added-number (or second added code), and a third added-number (or third added code), respectively.

For example, in a flow instance as illustrated in FIG. 5, when events whose attribute values of the added-number attributes (the values may hereinafter be referred to as “added-number values”) are the same are grouped into the same group, results as illustrated in FIG. 5 are obtained. In FIG. 5, since any added-number attribute is not set for the events A and M, it is regarded that they are not executed in parallel. In FIG. 5, the events are broadly divided into two groups according to the values of the first added-number. More specifically, the events are grouped into a group 100 to which the events B, D, H, and I whose values of the first added-number are “1” belong and a group 200 to which the events C, E, F, G, J, K, and L whose values of the first added-number are “2” belong.

The events in the group 100 are further divided into two groups according to the values of the second added-number. More specifically, the events are divided into a group 110 to which the event H whose value of the second added-number is “c” belongs and a group 120 to which the event I whose value of the second added-number is “d” belongs. The events in the group 200 are further divided into two groups according to the values of the second added-number. More specifically, the events are grouped into two groups, e.g., a group 210 to which the events E and G whose values of the second added-number are “a” belong and a group 220 to which the events F, J, K, and L whose values of the second added-number are “b” belong.

The events in the group 220 are further divided into two groups according to the values of the third added-number. More specifically, the events are divided into a group 221 to which the event J whose value of the third added-number is “X” belongs and a group 222 to which the events K and J whose values of the third added-number are “Y” belong.

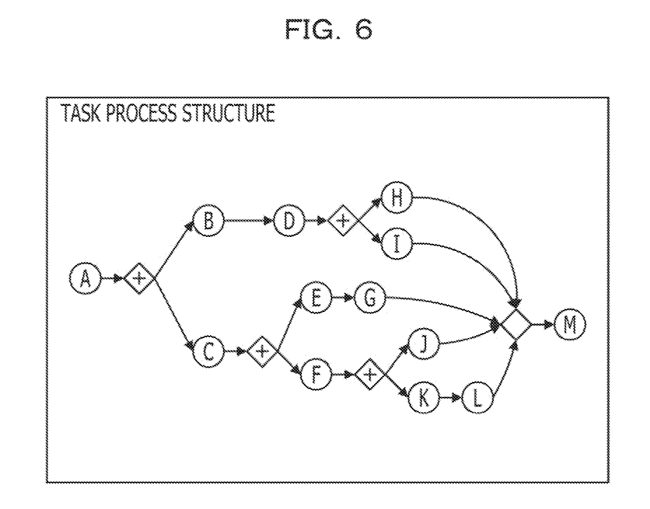

In the example of FIG. 5, the group with the first added-number includes the group with the second added-number and the group with the second added-number further includes the group with the third added-number, so that the ranges of the groups decrease gradually in order of the first, second, and third added-numbers. A parent-and-child relationship is satisfied between the first added-number and the second added-number and a parent-and-child relationship is also satisfied between the second added-number and the third added-number. In this case, through the use of an approach in which the events are placed in order of the time of event occurrence and a branch point is added at a point where the number of added-number attributes set for the corresponding one of the events increases, it is possible to derive a task process structure as illustrated in FIG. 6. Specifically, since no added-number attribute is initially set for the first event A, the event A is regarded as not being one of events executed in parallel and thus is directly placed. The first added-number is set for the next event B, so that the number of added-number attributes increases from 0 to 1 at this point. Thus, a branch point is provided between the event A and the event B. In FIG. 6, each diamond-shaped block with mark “+” therein indicates a branch point. With respect to the next event C, although the number of added-number attributes is still 1, the value of the first added-number is different from the value of the first added-number of the event B. Thus, a branch route that is different from the branch route for the event B is provided. In addition, with respect to the next event D, since the number of added-number attributes and the value of the first added-number are the same as those of the event B, the event D is placed on the same branch route as for the event B and after the event B. With respect to the next event E, since the value of the first added-number is the same as that of the event C, the event E is placed after the event C. However, since the second added-number is further set for the event E, the number of added-number attributes increases from 1 to 2. Thus, a branch point is provided between the event C and the event E. With respect to the next event F, although the number of added-number attributes and the value of the first added-number are the same as those of the event E, the value of the second added-number is different from that of the event E and thus a branch route that is different from the branch route for the event E is provided. In addition, with respect to the next event G, since the number of added-number attributes and the values of the first and second added-numbers are the same as those of the event E, the event G is placed on the same branch route as for the event E and after the event E. In addition, with respect to the next event H, since the value of the first added-number is the same as that of the event D, the event H is placed after the event D. However, since the second added-number is further set for the event H, the number of added-number attributes increases from 1 to 2. Thus, a branch point is provided between the event D and the event H. With respect to the next event I, although the number of added-number attributes and the value of the first added-number are the same as those of the event H, the value of the second added-number is different from that of the event H and thus a branch route that is different from the branch route for the event H is provided. With respect to the next event J, since the values of the first and second added-numbers are the same as those of the event F, the event J is placed after the event F. However, since the third added-number is further set for the event J, the number of added-number attributes increases from 2 to 3. Thus, a branch point is provided between the event F and the event J. With respect to the next event K, although the number of added-number attributes and the values of the first and second added-numbers are the same as those of the event J, the value of the third added-number of the event K is different from that of the event J and thus a branch route that is different from the branch route for the event J is provided. In addition, with respect to the next event L, since the number of added-number attributes and the values of the first to third added-numbers are the same as those of the event K, the event L is placed on the same branch route as for the event K and after the event K. With respect to the last event M, since no added-number attribute is set, the event M is placed after all the branch routes are merged together.

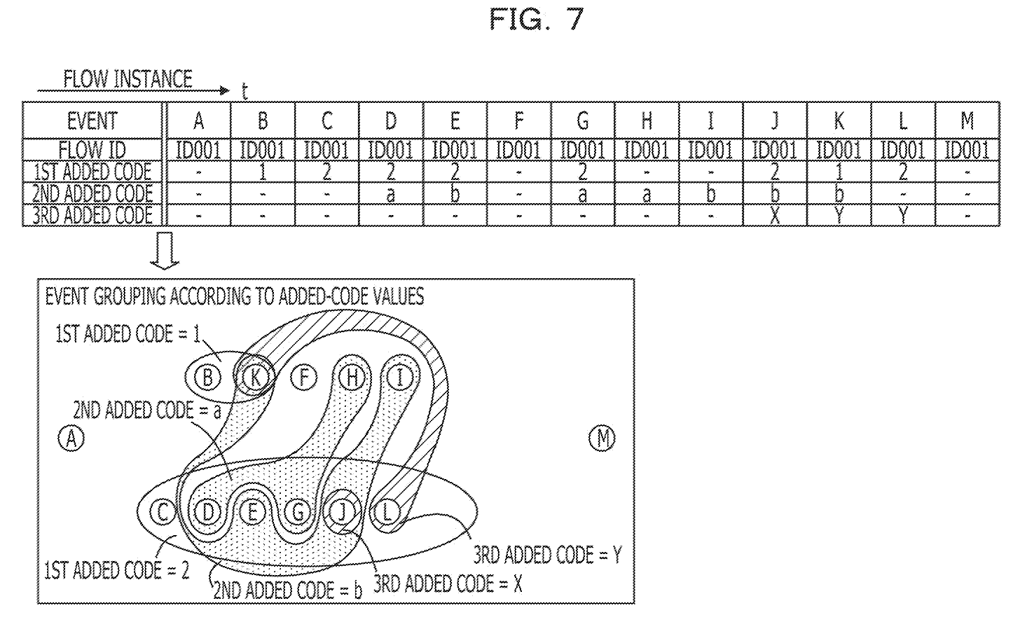

Although the parent-and-child relationship is satisfied between the added-number attributes in the example illustrated in FIG. 5, there is also a case in which a parent-and-child relationship is not satisfied between added-number attributes, for example, as illustrated in FIG. 7. When a flow instance illustrated in FIG. 7 is grouped according to the added-number values, results illustrated in FIG. 7 are obtained. As illustrated in FIG. 7, the correlations between the added-number attributes are complicated and no parent-and-child relationship is satisfied. In this case, it is difficult to estimate a task process structure by using an approach as described above.

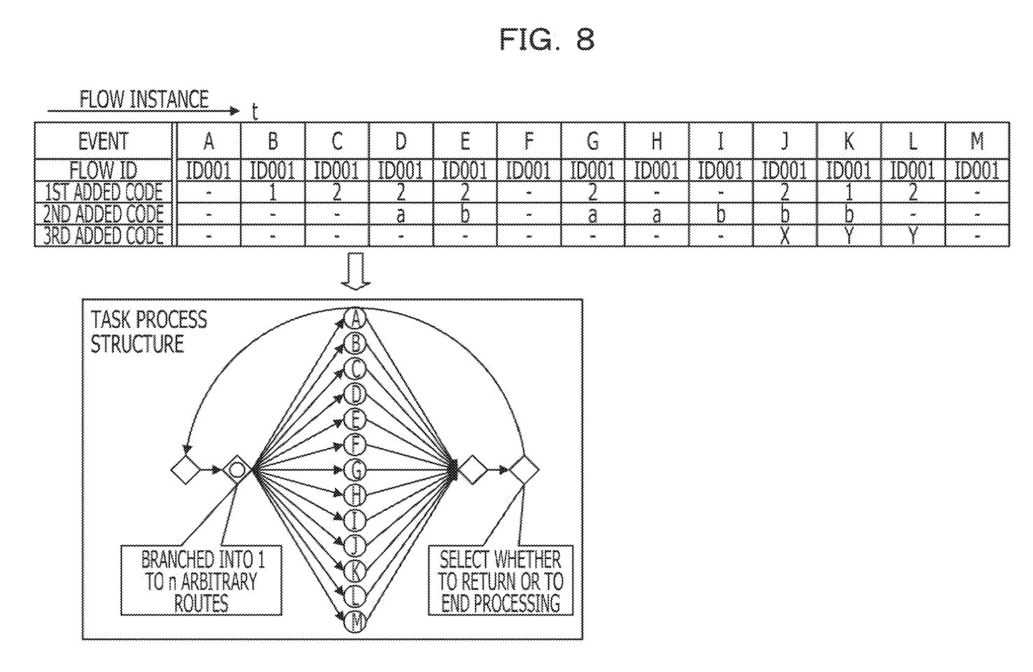

For example, a task process structure as illustrated in FIG. 8 can be estimated from the flow instance illustrated in FIG. 7. The flow instance illustrated in FIG. 8 is substantially the same as the flow instance illustrated in FIG. 7. In the task process structure illustrated in FIG. 8, the diamond-shaped block with symbol “O” therein indicates a branch point at which one route is branched into n arbitrary routes. This task process structure is such that, after the routes are merged together, the route returns to the pre-branching point, as needed. However, even when such a task process structure is output as an estimation result, the structure is an unspecific structure and thus may not be used for improving task processes and so on. Thus, significant estimation is hardly possible. Accordingly, in an embodiment of this technology, an approach as described below is employed to make it possible to achieve significant estimation of a task process structure even when the correlations between added-number attributes are complicated. One embodiment of the present technology is described below.

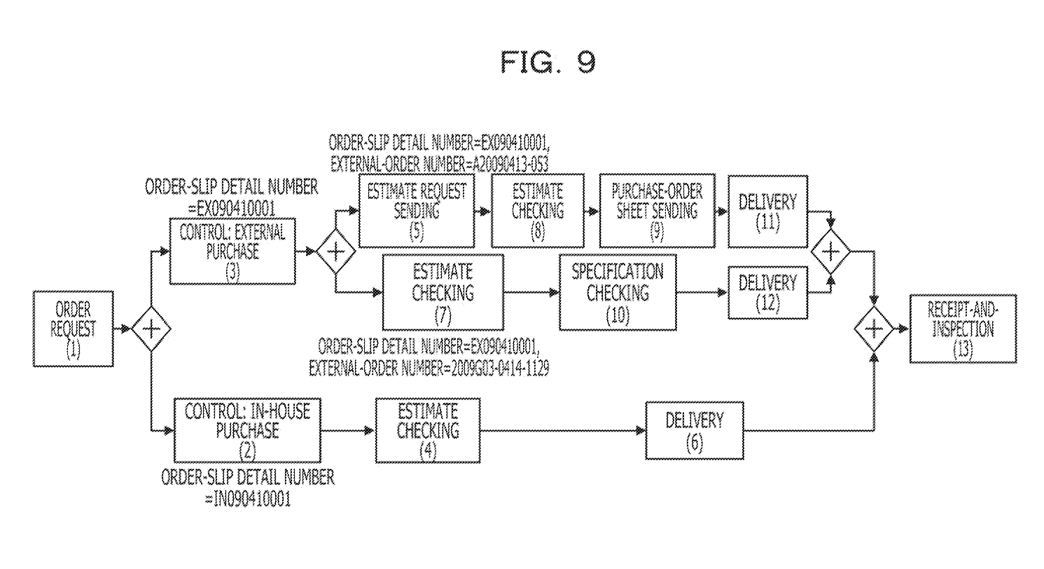

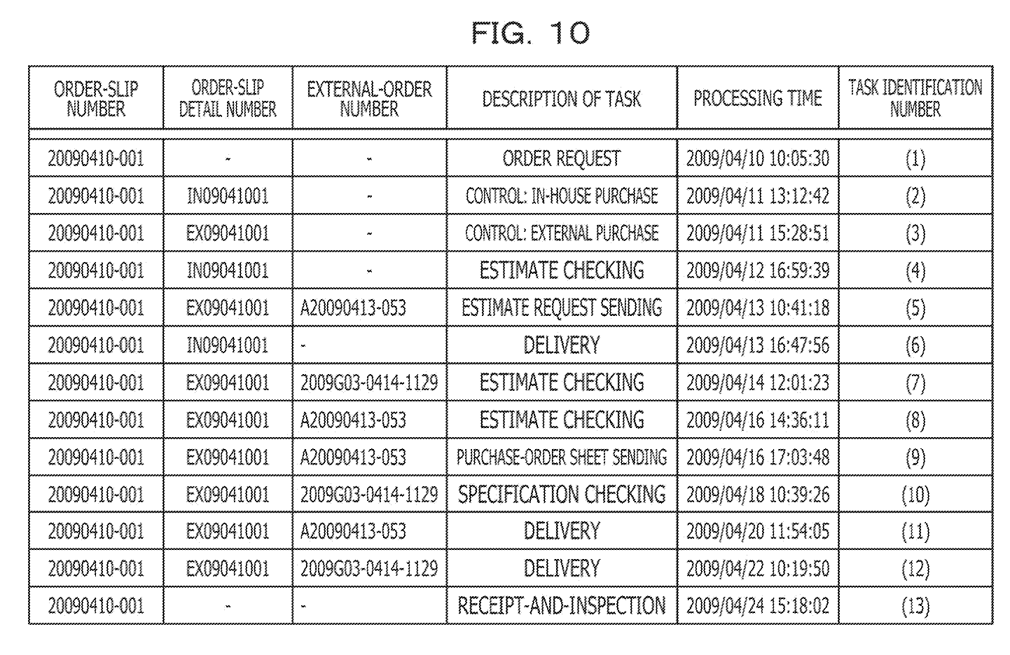

Before specific details of the present embodiment are described, a specific example of an added-number attribute will be described with reference to FIGS. 9 and 10. For example, FIG. 9 illustrates one example of a flow of a series of task processing executed in an order system. FIG. 10 also illustrates one example of a flow instance for the flow illustrated in FIG. 9. For clarity of the relationships between blocks in FIG. 9 and processing records in FIG. 10, they are denoted by corresponding task identification numbers. For example, an order request (1) in FIG. 9 corresponds to, in FIG. 10, a processing record with a task identification number of (1). The task identification numbers are given in order of processing time.

In the flow illustrated in FIG. 9, the order request (1) is issued first. In this case, a unique order-slip number is issued for the order processing. Tasks having the same order-slip number indicate that they are a series of order processing for the same case. For example, the order request is sent to a purchasing department, where the request is divided into a request for in-house procurement and a request for external purchase. The purchasing department performs control processing for checking whether or not content of the order is appropriate. Since the processing differs between an in-house order [control: in-house purchase (2)] and an external order [control: external purchase (3)], an order-slip detail number for distinguishing therebetween is issued. In this case, order-slip detail number “IN090410001” is set for the processing for the in-house purchase and order-slip detail number “EX090410001” is issued for the processing for the external purchase. These order-slip detail numbers correspond to a first type of added-number attribute.

For a route for the in-house purchase, for example, the processing for the in-house purchase is centralized and one department can perform all purchase processing. Thus, no rebranching occurs after the control processing and estimate checking (4) and delivery (6) are performed. In this case, the processing for the in-house purchase is computerized, so that, after an estimate request is issued, the estimate can be immediately checked. Thus, data of the estimate request and data of the estimate checking are integrally recorded as estimate checking. In this case, it is assumed that receipt-and-inspection processing after the deliveries is performed only once with respect to a single order request, regardless of the constitution of purchased products, and is not executed until all deliveries are completed.

On the other hand, for a route for the external purchase, details of the processing for the external purchase vary depending on an entity with which an order is placed, and thus an external-order number is issued for each entity with which an order is placed. In this case, external-order number “A20090413-053” is set for an order placed with company A and external-order number “2009G03-0414-1129” is set for an order placed with company B. These external-order numbers correspond to a second type of added-number attribute.

For example, it is assumed that an order system for company A is paper-based with respect to an order placed with company A and an estimate request and so on are to be sent in the form of paper documents. Thus, in the flow in FIG. 9, processing is performed according to a flow of estimate-request sending (5), estimate checking (8), purchase-order sheet sending (9), and delivery (11).

For example, it is assumed that the order system in company B is computerized with respect to an order placed with company B and specifications of the ordered product are to be checked before the delivery since it is a special order product. Thus, in the flow in FIG. 9, processing is performed according to the flow of estimate checking (7), specification checking (10), and delivery (12).

After deliveries of the in-house and external orders are completed, receipt-and-inspection (13) is executed and the series of the order processing is completed. Although FIGS. 9 and 10 illustrate a specific example in which two types of added-number attribute are set, the types of added-number attribute are not limited thereto and three or more types of added-number attribute may be used.

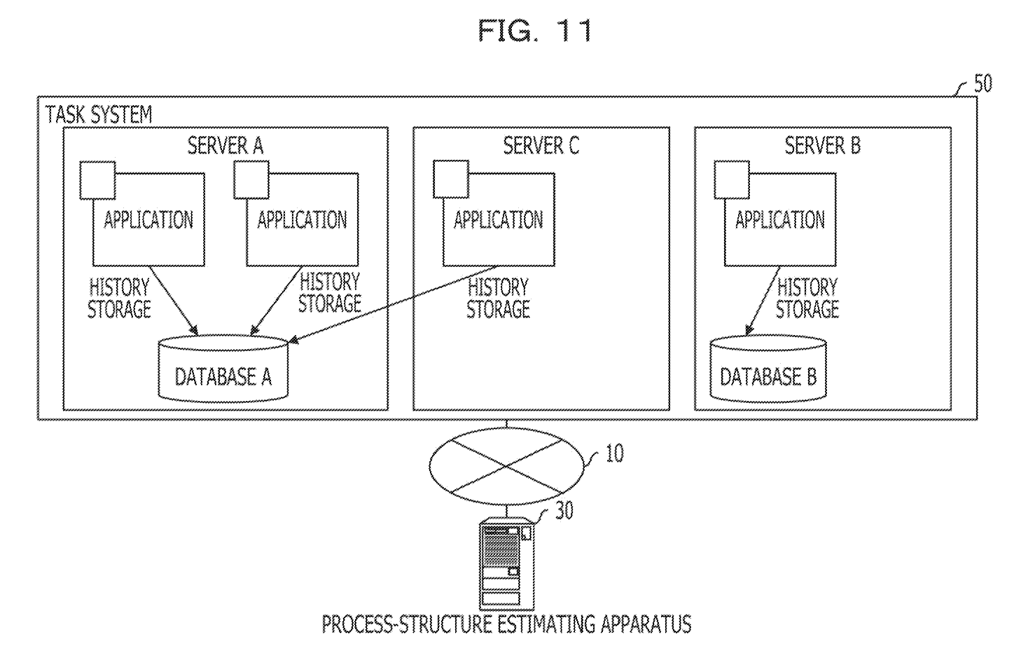

FIG. 11 is a schematic diagram of a system according to one embodiment of the present technology. In FIG. 11, for example, a process-structure estimating apparatus 30 and a task system 50 are connected through a network 10, such as an in-house LAN (local area network) or the Internet. The process-structure estimating apparatus 30 executes primary processing in the present embodiment. The task system 50 includes multiple servers (servers A to C in the case of FIG. 11).

The servers in the task system 50 have applications for executing task processing and databases A and B in which histories of processing executed by the applications are stored. One or some of the servers may have no database, in which case, the history is stored in the database of another server.

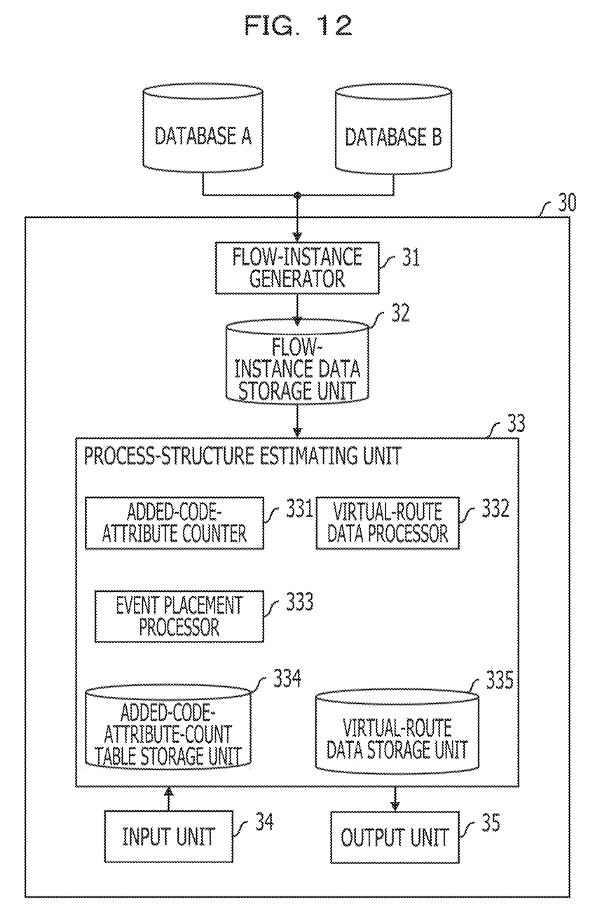

FIG. 12 is a functional block diagram of the process-structure estimating apparatus 30 illustrated in FIG. 11. The process-structure estimating apparatus 30 according to the present embodiment includes a flow-instance generator 31, a flow-instance data storage unit 32, a process-structure estimating unit 33, an input unit 34, and an output unit 35. The flow-instance generator 31 generates a flow instance on the basis of data stored in the databases A and B (or replicas thereof) in the task system 50. The flow-instance data storage unit 32 stores data of the flow instance generated by the flow-instance generator 31. The input unit 34 receives, from a user, a selection input of a flow instance to be processed and outputs data of the selection input to the process-structure estimating unit 33. The process-structure estimating unit 33 executes processing for estimating a process structure on the basis of the data stored in the flow-instance data storage unit 32. The output unit 35 outputs a result of the processing performed by the process-structure estimating unit 33.

The process-structure estimating unit 33 includes an added-number-attribute counter 331 (or added-code-attribute counter), a virtual-route data processor 332, an event placement processor 333, an added-number-attribute-count table storage unit 334, and a virtual-route data storage unit 335. On the basis of the data stored in the flow-instance data storage unit 32, the added-number-attribute counter 331 counts the number of added-number attributes set for each of the task events in the flow instance to be processed. The virtual-route data processor 332 performs processing, such as generation of virtual route data described below. The event placement processor 333 performs event placement processing described below. The added-number-attribute-count table storage unit 334 stores an added-number-attribute-count table including results of the processing performed by the added-number-attribute counter 331. The virtual-route data storage unit 335 stores results of the processing performed by the virtual-route data processor 332.

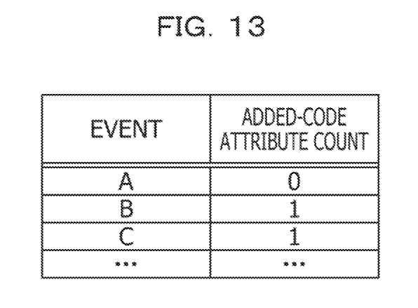

FIG. 13 illustrates one example of the added-number-attribute-count table stored in the added-number-attribute-count table storage unit 334. In the example of FIG. 13, the added-number-attribute-count table has a column for events and a column for the added-number attribute counts, so as to store the number of added-number attributes set for each event.

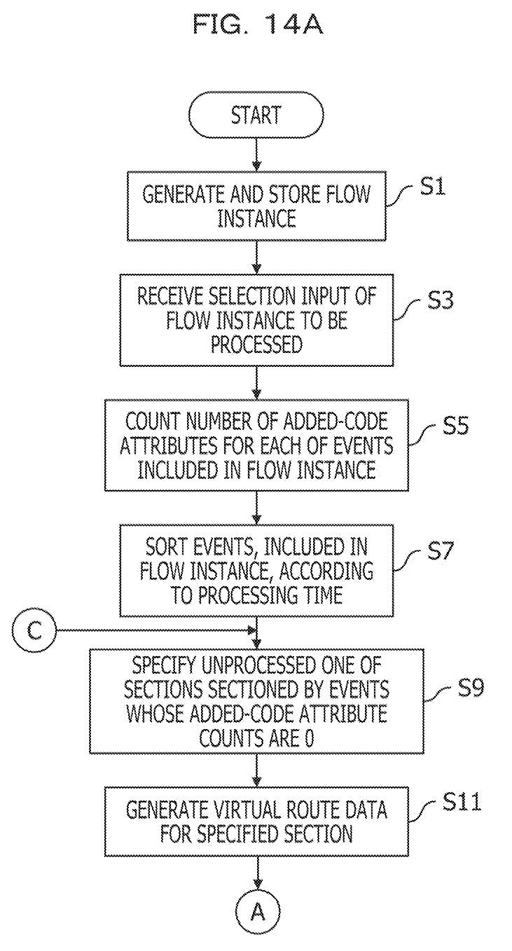

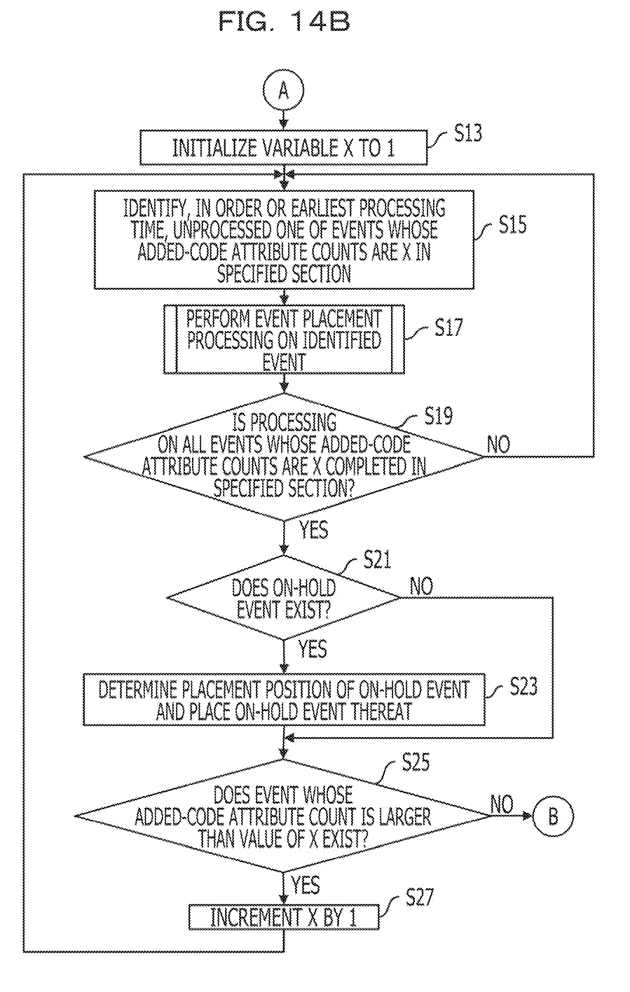

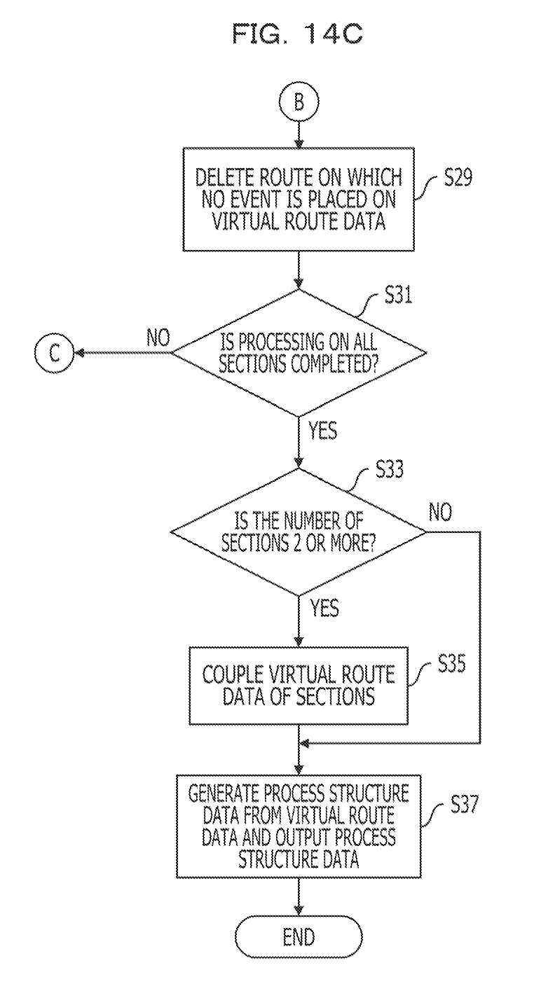

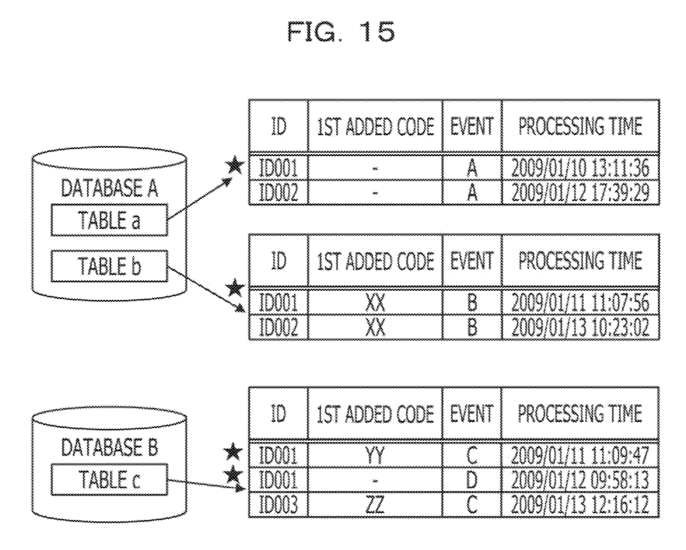

Next, a processing flow for the process-structure estimating apparatus 30 will be described with reference to FIGS. 14A to 23B. First, in operation S1 in FIG. 14A, the flow-instance generator 31 generates a flow instance from data stored in a group of databases, such as the databases A and B, in the task system 50 and stores the generated flow instance in the flow-instance data storage unit 32. The processing of this operation will now be described with reference to FIG. 15.

For example, as schematically illustrated in FIG. 15, tables a and b are stored in the database A and the flow-instance generator 31 extracts each processing record including an ID, a first added-number (or first added-code), an event, and processing time from the table a and similarly extracts each processing record including an ID, a first added-number (or first added-code), an event, and processing time from the table b. A table c is stored in the database B, and the flow-instance generator 31 extracts each processing record including an ID, a first added-number (or first added-code), an event, and processing time from the table c. Although FIG. 15 illustrates an example in which the number of columns for the added-number attributes is one, the number of columns therefor may be two or more. The ID is data corresponding to, for example, the order-slip number illustrated in FIG. 10 and the first added-number is data corresponding to, for example, the order-slip detail number illustrated in FIG. 10. Which attributes correspond to the identifier and the added-number vary depending on the individual task system.

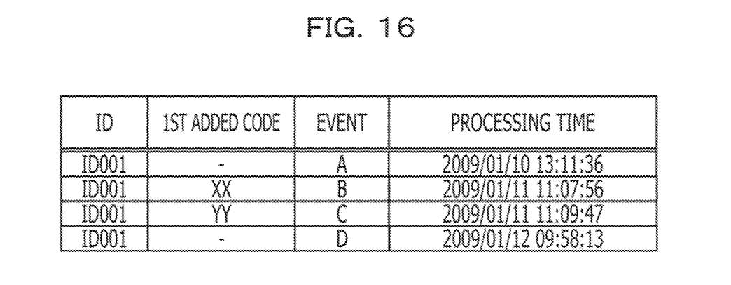

The flow-instance generator 31 sorts the extracted processing records according to the ID and stores the sorted results in the flow-instance data storage unit 32. Tasks having the same order-slip number indicate that they are a series of tasks for the same case. In this case, the processing records may further be sorted according to the processing time. When the asterisked processing records with ID001 are grouped in the example of FIG. 15, data as illustrated in FIG. 16 are generated and stored in the flow-instance data storage unit 32. Processing records other than those with ID001 are similarly grouped and resulting data are stored in the flow-instance data storage unit 32.

Thereafter, in operation S3, the input unit 34 receives, from the user, a selection input of a flow instance to be processed and outputs data of the selection input to the process-structure estimating unit 33.

The process-structure estimating unit 33 receives the selection input data from the input unit 34. In operation S5 in FIG. 14A, on the basis of the data stored in the flow-instance data storage unit 32, the added-number-attribute counter 331 in the process-structure estimating unit 33 counts the number of added-number attributes set for each of the events included in the flow instance to be processed (the number may also be referred to as a “added-number attribute count”) and stores the added-number attribute counts in the added-number-attribute-count table storage unit 334.

Subsequently, in operation S7, the process-structure estimating unit 33 sorts the events, included in the flow instance to be processed and stored in the flow-instance data storage unit 32, according to the processing time. When the events are sorted according to the processing time at the time of operation S1, the processing in operation S7 may be omitted.

Thereafter, in operation S9, on the basis of the data stored in the flow-instance data storage unit 32, the virtual-route data processor 332 in the process-structure estimating unit 33 specifies, in the flow instance to be processed, an unprocessed one of sections sectioned by the events whose added-number attribute counts are 0. For example, when one event whose added-number attribute count is 0 exists midway in the flow instance, the flow instance is sectioned into a section between the first event and the event that exists midway and a section between the event that exists midway and the last event. Thus, the event whose added-number attribute count is 0 and which exists midway is processed as belonging to both of the front section and the rear section. When any event whose added-number attribute count is 0 does not exist midway, this indicates that only one section exists between the first event and the last event.

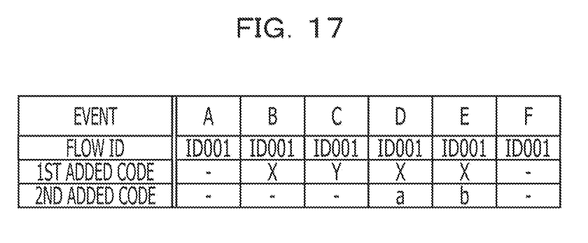

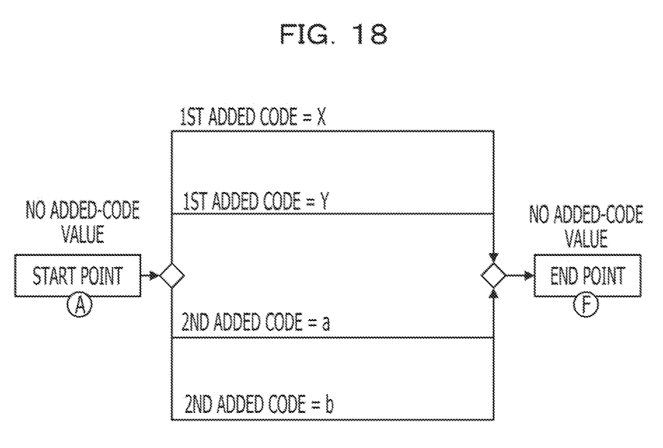

In operation S11, the virtual-route data processor 332 generates virtual route data for the specified section on the basis of the data stored in the flow-instance data storage unit 32 and stores the generated virtual route data in the virtual-route data storage unit 335. The processing in this operation will now be described with reference to FIGS. 17 and 18.

FIG. 17 illustrates one example of a flow instance and FIG. 18 illustrates virtual route data generated from the flow instance illustrated in FIG. 17. In the example of FIG. 17, six events, e.g., events A to F, are included in the flow instance. In the example of FIG. 17, the events A to F are time-sequentially arranged from left to right. Two types of added-number attribute, e.g., a first added-number (first added-code) and a second added-number (second added-code), exist. “X” or “Y” is set for the first added-number and “a” or “b” is set for the second added-number. In this case, when all of pairs of the added-number attributes and the attribute values thereof are extracted, four pairs, e.g., a pair with a first added-number of X, a pair with a first added-number of Y, a pair with a second added-number of a, and a pair with a second added-number of b, are obtained. The total number of extracted pairs is equal to the number of branch routes included in the virtual route data to be generated in operation S11 described above. A start point, a branch point, a merge point, and an end point are placed, and a line coupling the start point and the branch point, four branch routes coupling the branch point and the merge point, and a line coupling the merge point and the end point are set to generate virtual route data as illustrated in FIG. 18. In FIG. 18, the topmost branch route is a branch route for the first added-number=X, the second branch route from the top is a branch route for the first added-number=Y, the third branch route from the top is a branch route for the second added-number=a, and the bottommost branch route is a branch route for the second added-number=b. The events whose added-number attribute counts are 0 are placed at the start point and the end point. In the example of FIG. 18, the event A is placed at the start point and the event F is placed at the end point. Although the event whose added-number attribute count is 0 corresponds to the start point or the end point in this case, there is a case in which an event whose added-number attribute count is 0 does not exist at the beginning or the end of a section to be processed. In this case, a virtual edge point is set as the start point or the end point. Nodes on the virtual route data represent events (e.g., a node “A” represents the event A, and the same applies to other nodes).

After the processing in operation S11 is performed, the process proceeds to processing in operation S13 (in FIG. 14B) via terminal A.

Referring to FIG. 14B, in operation S13 after terminal A, the event placement processor 333 initializes a variable X to 1. In the present embodiment, events are placed on a virtual route in ascending order of the added-number attribute counts of the events, as described below. The variable X represents the added-number attribute count of an event to be processed and is adapted to be incremented by 1 in operation S27 described below.

In operation S15, on the basis of the data stored in the flow-instance data storage unit 32 and the added-number-attribute-count table storage unit 334, the event placement processor 333 identifies, in the order of earliest processing time, an unprocessed one of events for which X added-number attributes are set (e.g., events whose added-number attribute counts are X) in the section specified in operation S9 (FIG. 14A). For example, in the case of the flow instance illustrated in FIG. 17, when the value of the variable X is 1, the events B and C are extracted. In the example of FIG. 17, since the processing time of the event B is earlier, the event B is first identified and then the event C is identified.

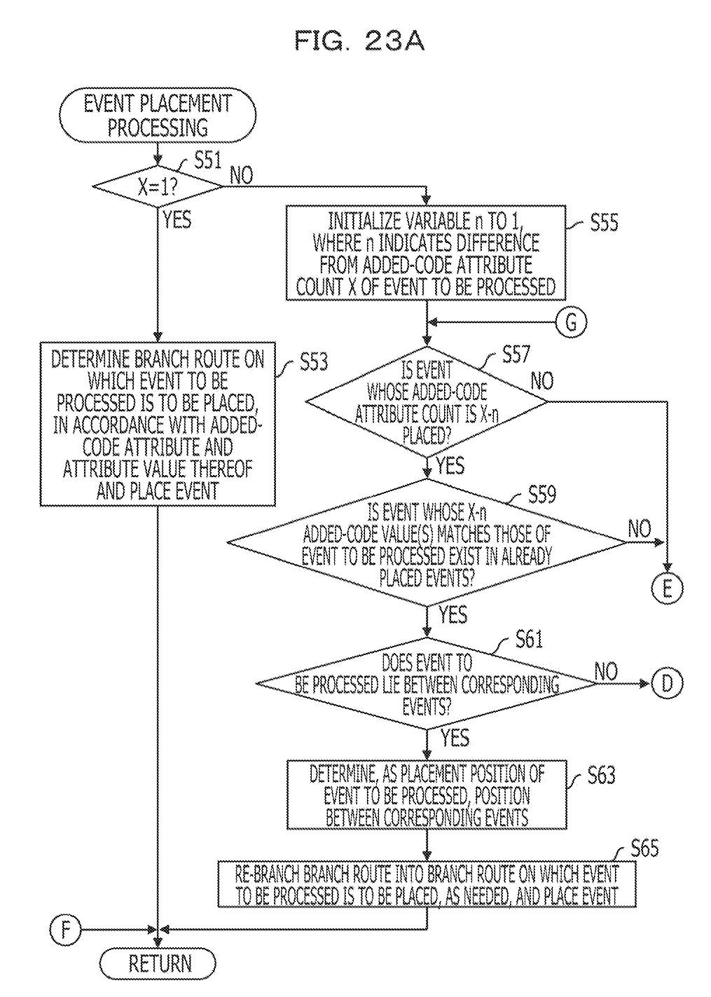

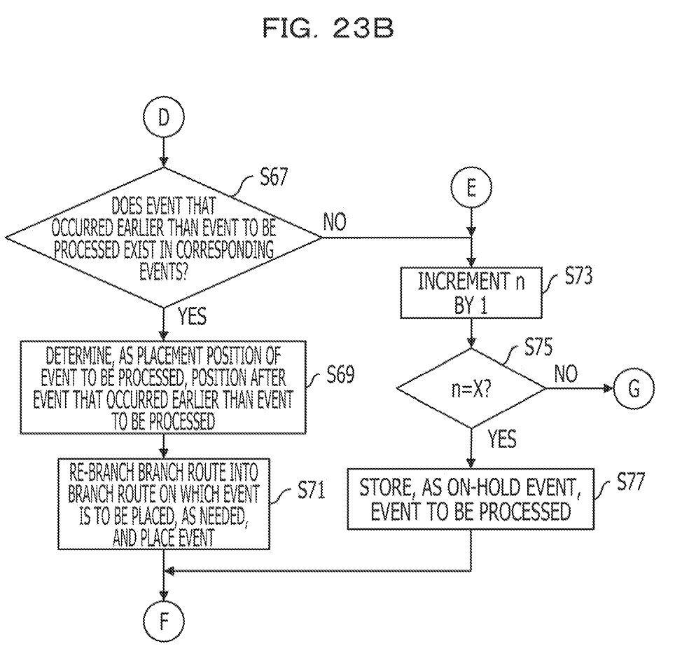

In operation S17, the event placement processor 333 performs event placement processing on the identified event, by using the data stored in the flow-instance data storage unit 32 and the virtual-route data storage unit 335. While the event placement processing is described below in detail with reference to FIGS. 23A and 23B, an overview of the processing will now be described.

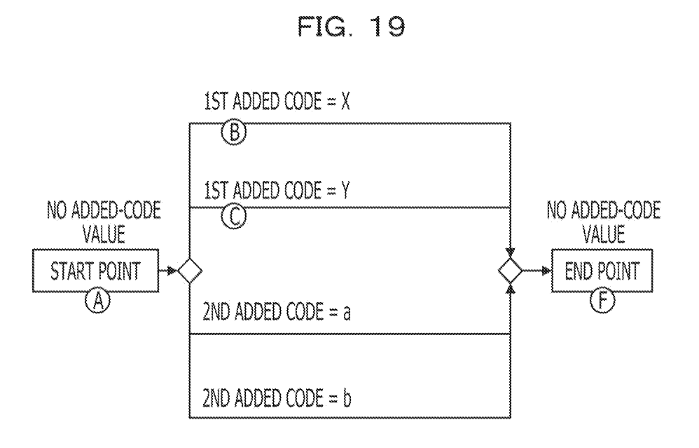

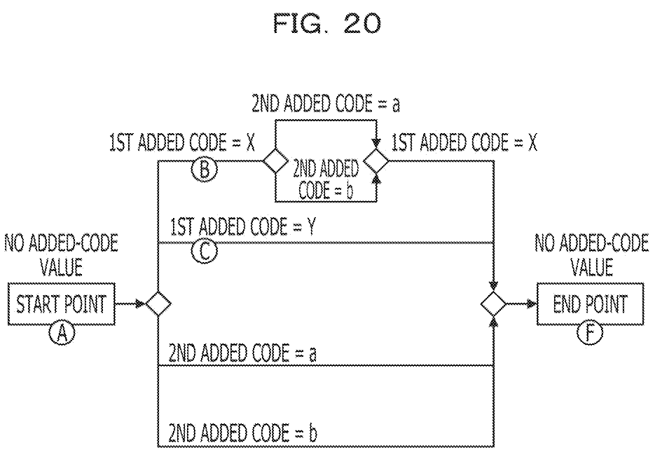

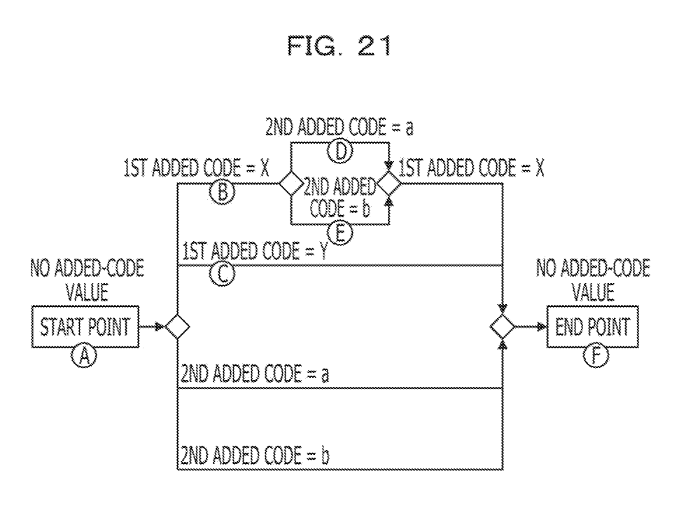

In the event placement processing, a position at which event to be processed is to be placed is determined in accordance with a rule, and the event to be processed is placed at the determined position to update the virtual route data, as illustrated in FIG. 19. In the example of FIG. 19, the event B is placed on the branch route with the first added-number=X and the event C is placed on the branch route with the first added-number=Y. For example, as illustrated in FIG. 20, a branch route on which an event to be processed is to be placed is re-branched, as needed. In the example of FIG. 20, a new branch point and a new merge point are set on the branch route with the first added-number=X and the branch route is re-branched into a branch route with the second added-number=a and a branch route with the second added-number=b. As illustrated in FIG. 21, the position at which the event is to be placed is re-set on a post-rebranching branch route and the event to be processed is placed on the re-set position. In the example of FIG. 21, the event D is placed on the post-rebranching branch route with the second added-number=a and the event E is placed on the post-rebranching branch route with the second added-number=b.

For an event whose added-number attribute count is 2 or more, there is a case in which the position at which the event is to be placed may not be uniquely determined, details of which are described below. Such an event is temporarily stored in a storage device as an on-hold event and the position at which the event is to be placed is determined after a series of processing is performed on the events whose added-number attribute counts are X.

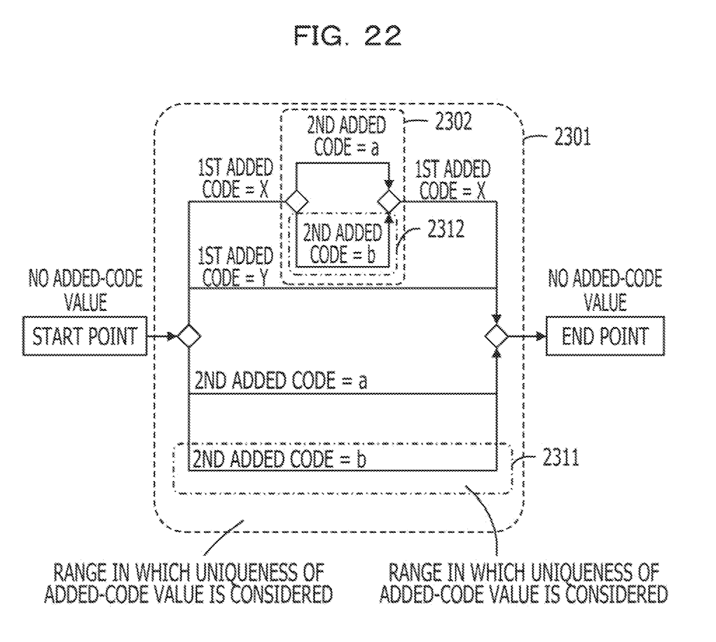

FIG. 22 illustrates ranges in which the added-number values on the virtual route data are valid and ranges in which the order of events is maintained. Each of dotted frames 2301 and 2302 in FIG. 22 indicates a range in which the added-number value is valid and each of dashed-dotted lines 2311 and 2312 indicates a range in which the order of the events is maintained. The range in which the added-number value is valid does not overlap another section. This is because, when multiple sections exist, meanings at different sections are different from each other even for the same added-number value. Events belonging to the same route are placed on the route according to the order of occurrence, without a need for consideration of the order of occurrence in relation to an event on another route.

After the event placement processing (in operation S17) is performed, the process proceeds to operation S19 in which the event placement processor 333 determines whether or not the processing on all events whose added-number attribute counts are X is completed in the specified section. When the processing on all events whose added-number attribute counts are X is not completed in the specified section (e.g., No in operation S19), the process returns to operation S15 and the processing described above is repeated.

On the other hand, when the processing on all events whose added-number attribute counts are X is completed in the specified section (Yes in operation S19), the process proceeds to operation S21 in which the event placement processor 333 determines whether or not any on-hold event exists. When an on-hold event exists (Yes in operation S21), the process proceeds to operation S23 in which the event placement processor 333 determines a position at which the on-hold event is to be placed and places the on-hold event at the determined position to thereby update the virtual route data. For example, when three on-hold events, e.g., an event S (the first added-number=Z and the second added-number=c), an event T (the first added-number=Z and the second added-number=d), and an event U (the first added-number=Z and the second added-number=d), exist, it is determined that the three on-hold events can be placed together on the branch route with the first added-number=Z, since the first added-number=1 is common to the three on-hold events. The branch route with the first added-number=Z is re-branched into a branch route with the second added-number=c and a branch route with the second added-number=d and the on-hold events are placed on the corresponding post-rebranching branch routes. Although the second added-number=d is also common to the events T and U in this example, the virtual route data that allows a larger number of on-hold events to be placed together may be used. After the processing in operation S23, the process proceeds to processing in operation S25.

When no on-hold event exists (No in operation S21), the process skips the processing in operation S23 and proceeds to the processing in operation S25.

In operation S25, the event placement processor 333 searches the flow-instance data storage unit 32 to determine whether or not an event whose added-number attribute count is larger than the value of X exists. When an event whose added-number attribute count is larger than the value of X exists (Yes in operation S25), the process proceeds to operation S27 in which the event placement processor 333 increments the variable X by 1. The process then returns to operation S15 and the processing described above is repeated.

On the other hand, when an event whose added-number attribute count is larger than the value of X does not exist (No in operation S25), the process proceeds to operation S29 (in FIG. 14C) via terminal B.

Referring to FIG. 14C, in operation S29 after terminal B, the virtual-route data processor 332 updates the virtual route data by deleting, on the virtual route data in the virtual-route data storage unit 335, a branch route on which no event is placed. When a portion where a branch point and a merge point continue exists on the virtual route data, they are integrated into one. In operation S31, the virtual-route data processor 332 determines whether or not the processing on all sections is completed. When the processing on all sections is not completed (No in operation S31), the process returns to operation S9 via terminal C and the processing described above is repeatedly performed on the unprocessed section.

When the processing is completed on all sections (Yes in operation S31), the process proceeds to operation S33 in which the virtual-route data processor 332 determines whether or not the number of sections is 2 or more. When the number of sections is 2 or more (Yes in operation S33), the process proceeds to operation S35 in which the virtual-route data processor 332 couples the virtual route data of the sections. For example, when three sections exist, the virtual-route data processor 332 couples the end point of the virtual route data of the first section and the start point of the virtual route data of the second section and couples the end point of the virtual route data of the second section and the start point of the virtual route data of the third section. For example, since nodes for the same event are placed at the end point of the virtual route data of the first section and the start point of the virtual route data of the second section, they are coupled so that only one point exists on the route, for example, through deletion of one of the points. Thereafter, the process proceeds to processing in operation S37.

When the number of sections is 1 (No in operation S33), the process skips the processing in operation S35 and proceeds to the processing in operation S37.

In operation S37, the virtual-route data processor 332 generates process structure data from the virtual route data stored in the virtual-route data storage unit 335 and causes the output unit 35 to output the generated process structure data on a display device or the like. Thereafter, the processing ends.

Sequentially placing the events on the virtual route data in ascending order of the added-number attribute counts of the events makes it possible to determine a placement of an event to be processed, while considering a relative positional relationship with an event whose value of the added-number attribute count is small. When multiple sections exist, a case in which the added-number value used in a previous section is re-used in a subsequent section is conceivable. However, generation of virtual route data for each section allows the same added-number to be handled as a different value when the section changes.

Although the processing in operation in S29 is performed for each section in the above-described processing flow, it may also be changed to a processing flow in which the processing in operation S29 is performed only once after the processing in operation S35 is performed.

Next, details of the event placement processing will be described with reference to FIGS. 23A and 23B. First, in operation S51 in FIG. 23A, the event placement processor 333 determines whether or not the value of the variable X is 1. When the value of the variable X is 1 (Yes in operation S51), the process proceeds to operation S53 in which the event placement processor 333 determines a branch route on which an event to be processed is to be placed, in accordance with the added-number attribute (or added-code attribute) set for the event to be processed and the attribute value of the added-number attribute, and places the node of the event to be processed on the determined branch route. For example, the virtual route data is updated to data as illustrated in FIG. 19. Thereafter, the processing ends and the process returns to the initial processing.

On the other hand, when the value of the variable X is not 1 (No in operation S51), e.g., when an event whose added-number attribute count is 2 or more is to be processed, the process proceeds to operation S55 in which the event placement processor 333 initializes a variable n to 1. When an event whose added-number attribute count is 2 or more is to be placed, the position at which the event is to be placed is determined while considering a relative relationship with already placed events. The variable n indicates a difference from the added-number attribute count (=the variable X) of an event to be processed and is adapted to be incremented by 1 in operation S73 (FIG. 23B) described below.

In operation S57, the event placement processor 333 determines whether or not any event for which X-n added-number attribute(s) is set (e.g., an event whose added-number attribute count is X-n) is placed on the virtual route data in the virtual-route data storage unit 335. When any event whose added-number attribute count is X-n is not placed on the virtual route data (No in operation S57), the process proceeds to operation S73 (in FIG. 23B) via terminal E.

On the other hand, when an event or events whose added-number attribute count(s) is X-n are placed on the virtual route data (Yes in operation S57), the process proceeds to operation S59 in which the event placement processor 333 determines whether or not any event whose X-n added-number value(s) matches the added-number value(s) of the event to be processed exists in the events placed on the virtual route data. When an event or events whose X-n added-number value(s) matches the added-number value(s) of the event to be processed do not exist in the events placed on the virtual route data (No in operation S59), the process proceeds to operation S73 (in FIG. 23B) via terminal E.

On the other hand, when an event or events whose X-n added-number value(s) matches the added-number value(s) of the event to be processed exist in the events placed on the virtual route data (Yes in operation S59), the process proceeds to operation S61 in which the event placement processor 333 determines whether or not the event to be processed lies between the events whose X-n added-number value(s) matches the added-number value(s) of the event to be processed. When the event to be processed does not lie between the events whose X-n added-number value(s) matches the added-number value(s) of the event to be processed (No in operation S61), the process proceeds to operation S67 (in FIG. 23B) via terminal D.

On the other hand, when the event to be processed lies between the events whose X-n added-number value(s) matches the added-number value(s) of the event to be processed (Yes in operation S61), the process proceeds to operation S63 in which the event placement processor 333 identifies, as a branch route on which the event to be processed is to be placed, a branch route on which the corresponding events are placed and determines, as a position at which the event to be processed is to be placed, a position between the corresponding events. When multiple pairs of events between which the event to be processed lies exist, the event that occurred earlier than the event to be processed and that has the processing time closest to the processing time of the event to be processed is identified and, of the multiple pairs, the pair including the identified event is used in the processing in operation S63.

In operation S65, the event placement processor 333 re-branches the branch route into a branch route on which the event to be processed is to be placed, as needed, and places the node of the event on the post-rebranching branch route. The processing for re-branching the branch route is described below in detail. After operation in S65, the processing ends and the process returns to the initial processing.

Referring to FIG. 23B, in operation S67 after terminal D, the event placement processor 333 determines whether or not an event that occurred earlier than the event to be processed exists in the events whose X-n added-number values match those of the event to be processed. When an event that occurred earlier than the event to be processed does not exist in the events whose X-n added-number values match those of the event to be processed (No in operation S67), the process proceeds to operation S73.

When an event that occurred earlier than the event to be processed exists in the events whose X-n added-number value(s) matches the added-number value(s) of the event to be processed (Yes in operation S67), the process proceeds to operation S69. In operation S69, the event placement processor 333 identifies, as a branch route on which the event to be processed is to be placed, the branch route on which the event that occurred earlier is placed, and determines a position after the earlier event as a position at which the event to be processed is to be placed. When the number of events that occurred earlier than the event to be processed is plural, the event placement processor 333 identifies an event whose processing time is the closest to the event to be processed and uses the identified event in the processing in operation S69.

In operation S71, the event placement processor 333 re-branches the branch route into a branch route on which the event to be processed is to be placed, as needed, and places the node of the event on the post-rebranching branch route. The processing in this operation will now be described with reference to FIGS. 19 to 21.

For example, the virtual route data in FIG. 19 corresponds to data when the events whose added-number attribute counts are 1 are placed in the case of the flow instance illustrated in FIG. 17. Thereafter, the process proceeds to processing for the events D and E whose added-number attribute counts are 2. In this case, with respect to the events D and E whose added-number attribute counts are 2, the value of the first added-number matches that of the event B and thus a position after the event B is determined as positions at which the events D and E are to be placed.

Thereafter, a determination is made as to whether or not the number of branchings (e.g., the number of branch points) on a path from the start point to the positions at which the events are to be placed is equal to the added-number attribute count. In this case, since the added-number attribute count is 2 and the number of branchings on the path from the start point to the placement position is 1, it is determined that the number of branchings is less than the added-number attribute count (e.g., the number of branchings<the added-number attribute count). In this case, the branch route is re-branched so that the number of branchings on the path from the start point to the placement position is equal to the added-number attribute count. More specifically, a branch route is set in accordance with the added-number attribute other than the added-number attribute(s) associated with the branch route(s) on the path from the start point to the placement position, thereby rebranching the branch route. In this example, since the first added-number=X is associated with the branch route on the path from the start point to the placement position, a branch route for the second added-number is set. Consequently, as illustrated in FIG. 20, the branch route with the second added-number (second added-code)=a and the branch route with the second added-number (second added-code)=b are set. Since the value of the second added-number of the event D is a, the placement position of the event D is re-set on the post-rebranching branch route with the second added-number=a and the event D is placed at the placement position. In addition, since the value of the second added-number of the event E is b, the placement position of the event E is re-set on the post-rebranching branch route with the second added-number=b and the event E is placed at the placement position. Thus, the virtual route data is updated to data as illustrated in FIG. 21. In operation S65, the branch route is re-branched in substantially the same manner.

On the other hand, when it is determined in operation S67 that an event that occurred earlier than the event to be processed does not exist in the events whose X-n added-number value(s) matches the added-number value(s) of the event to be processed (e.g., No in operation S67) or after terminal E, the process proceeds to processing in operation S73.

In operation S73, the event placement processor 333 increments the variable n by 1. In operation S75, the event placement processor 333 determines whether or not n=X is satisfied. When n=X is not satisfied (No in operation S75), the process returns to operation S57 via terminal G and the processing described above is repeatedly performed.

On the other hand, when n=X is satisfied (Yes in operation S75), the process proceeds to operation S77 in which the event placement processor 333 temporarily stores, in the storage device, the event to be processed as an on-hold event. The processing in this operation is performed when the placement position of the event to be processed may not be uniquely determined. The placement position of the on-hold event is determined in operation S23 (FIG. 14B) described above. After operation S77, the process returns to the processing in FIG. 23A via terminal F. Thereafter, the processing ends and the process returns to the initial processing.

For example, when the added-number attribute count of the event to be processed is 3 (X=3), a determination when the processing is performed for the first time (e.g., the processing for n=1) is made as to whether or not an event whose added-number attribute count is 2 is placed and a determination is further made as to whether or not an event whose added-number values match two values of those of the event to be processed exists. When a corresponding event does not exist, the variable n is incremented by 1 in operation S73. Since X is larger than n at this point, the process returns to operation S57. For example, when the processing is performed for the second time (e.g., the processing for n=2), a determination is made as to whether or not an event whose added-number attribute count is 1 is placed and a determination is further made as to whether or not an event whose added-number value matches one of the added-number values of the event to be processed exists. When a corresponding event does not exist, the variable n is incremented by 1 to satisfy n=X. Thereafter, the process proceeds to the processing in operation S77.

Performing processing as described above makes it possible to determine an appropriate placement position with respect to the event to be processed, considering a relative relationship with events already placed on the virtual route data.

The virtual route data can be managed using a data structure having elements including pairs of “keys” and “values”. One example is Map of “Java” (a trademark of Sun Microsystems, Inc.). Processing when map data is used will be described below.

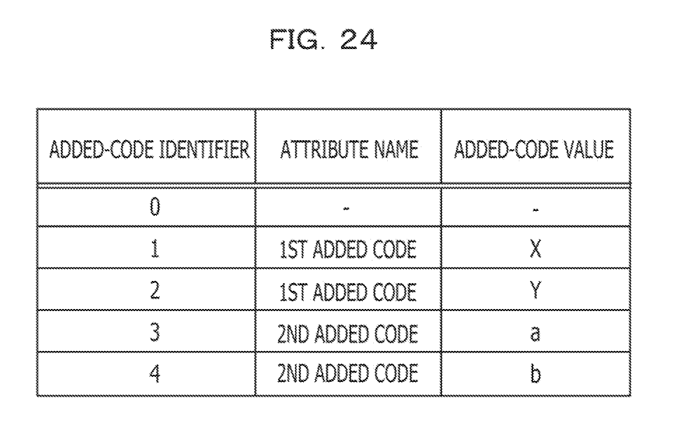

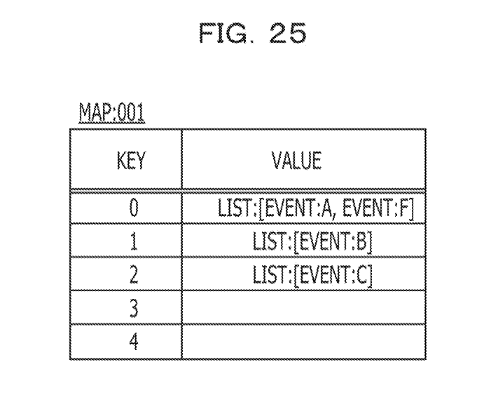

For example, the virtual-route data storage unit 335 stores an added-number management table (or added-code number management table) as illustrated in FIG. 24 and map data illustrated in FIG. 25. In the example of FIG. 24, the added-number management table has a column for added-number identifiers (or added-code identifiers), a column for added-number attribute names, and a column for added-number values (or added-code values). In the example of FIG. 25, the map data has a column for keys and a column for values. Data entered in the value column has a data structure like a list structure that can hold ordering. Value “List:[Event:A, Event:F]” in FIG. 25 indicates that the event A and the event F occurred in that order. FIG. 25 illustrates map data corresponding to the virtual route data illustrated in FIG. 19.

The event A and the event F are detected as events whose added-number attribute counts are 0 and are placed at the start point and the end point, respectively. In the added-number management table in FIG. 24, an identifier for “no added-number” (which is indicated by “−” in the added-number attribute name and the added-number value in FIG. 24) is “0”. Thus, the events A and F are registered in a list included in the map data and associated with the identifier “0”, in accordance with the order of time of occurrence.

The events B and C are detected as events whose added-number attribute counts are 1 and are placed on corresponding branch routes. In this case, in the added-number management table in FIG. 24, an identifier for the first added-number=X is “1” and an identifier for the first added-number=Y is “2”. Thus, the event B is registered in a list included in the map data and associated with the identifier “1” and the event C is registered in a list included in the map data and associated with the identifier “2”.

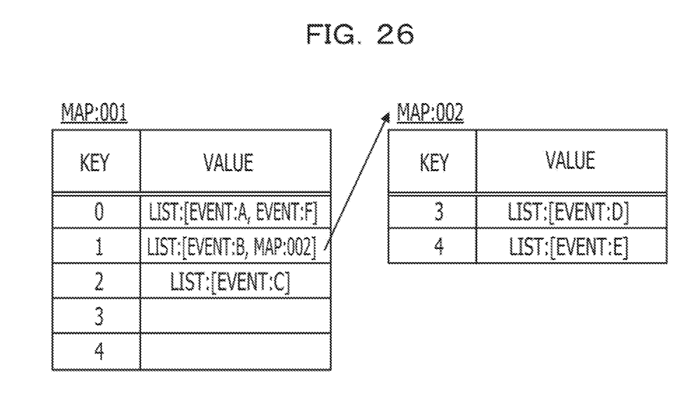

Thereafter, the events D and E are detected as events whose added-number attribute counts are 2. Since the first added-numbers=X of the events D and E match the added-number of the event B, a position after the event B is determined as a placement position. Subsequently, as illustrated in FIG. 20, the branch route with the first added-number=X is re-branched into the branch route with the second added-number=a and the branch route with the second added-number=b, and the event D is placed on the branch route with the second added-number=a and the event E is placed on the branch route with the second added-number=b, as illustrated in FIG. 21. When the rebranching is performed, other map data (Map: 002) is generated as illustrated in FIG. 26 and the newly generated map data is registered in the list in the original map data (Map: 001). In FIG. 26, the map data “Map: 002” is added after the event B in the list included in the map data “Map: 001” and associated with the identifier “1”. In this case, in the added-number management table in FIG. 24, an identifier for the second added-number=a is “3” and an identifier for the second added-number=b is “4”. Thus, in FIG. 26, in the map data “Map: 002”, the event D is registered in a list associated with the identifier “3” and the event E is registered in a list associated with the identifier 4.

The data structure described above is one example and another data structure may also be used to manage the virtual route data.

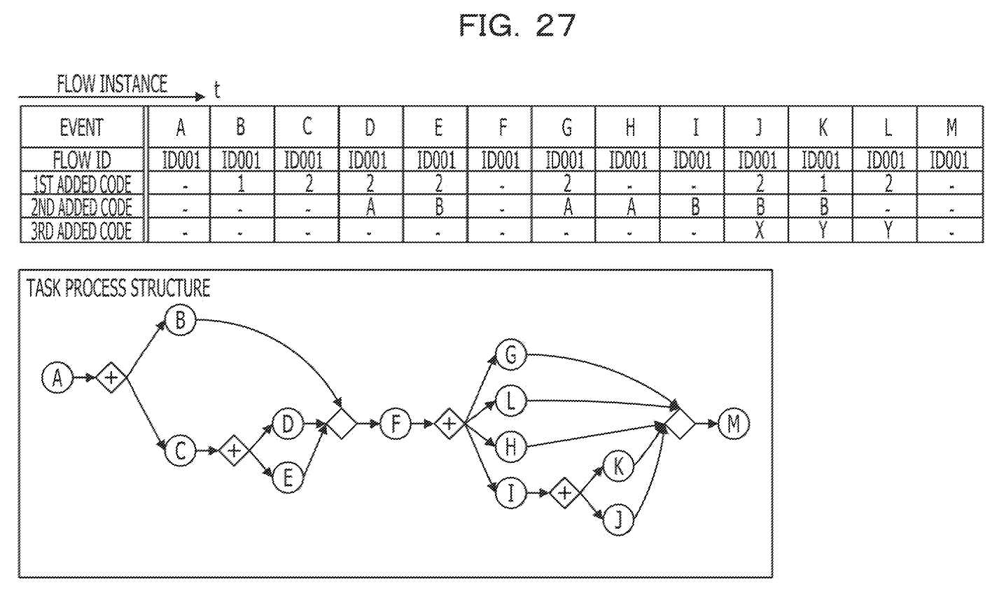

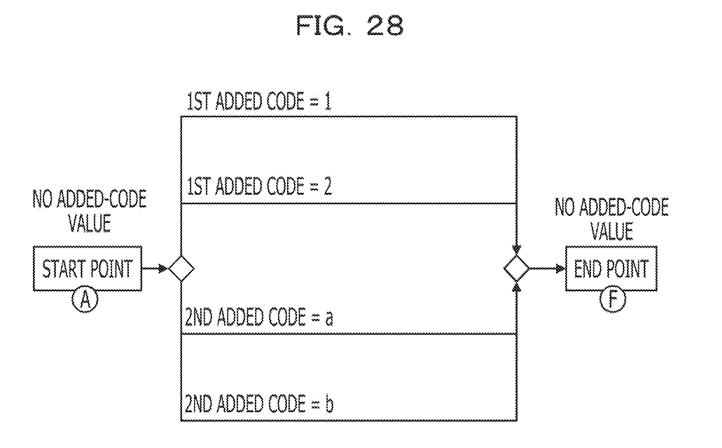

For example, with the grouping scheme described above with reference to FIG. 5, it is difficult to estimate a task process structure from the flow instance illustrated in FIG. 7. However, the scheme according to the present embodiment makes it possible to output, as an estimation result, a task process structure as illustrated in FIG. 27. The flow instance illustrated in FIG. 27 is substantially the same as the flow instance illustrated in FIG. 7. A flow until estimation results as illustrated in FIG. 27 are obtained will now be described with reference to FIGS. 28 to 35.

In the flow instance illustrated in FIG. 27, three events A, F, and M are events whose added-number attribute counts are 0. That is, the flow instance is sectioned into a first section between the event A and the event F and a second section between the event F and the event M.

The added-number values set for the events A to F in the first section are the first added-number=1, the first added-number=2, the second added-number=a, and the second added-number=b. Thus, when the processing in operation S11 (FIG. 14A) described above is performed on the first section, virtual route data as illustrated in FIG. 28 is generated. In FIG. 28, a first branch point coupled to a start point is branched into a branch route with the first added-number=1, a branch route with the first added-number=2, a branch route with the second added-number=a, and a branch route with the second added-number=b. The event A is placed at the start point and the event F is placed at an end point.

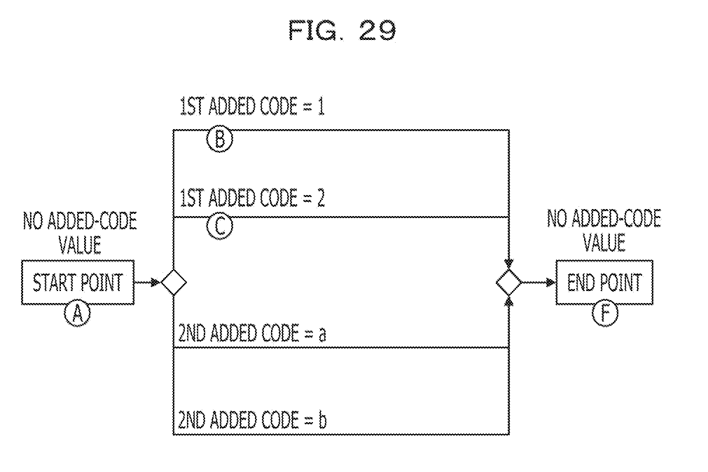

The processing is performed on the events B and C whose added-number attribute counts are 1. Upon completion of the processing, the virtual route data becomes data as illustrated in FIG. 29. In the example of FIG. 29, the event B is placed on the branch route with the first added-number=1 and the event C is placed on the branch route with the first added-number=2.

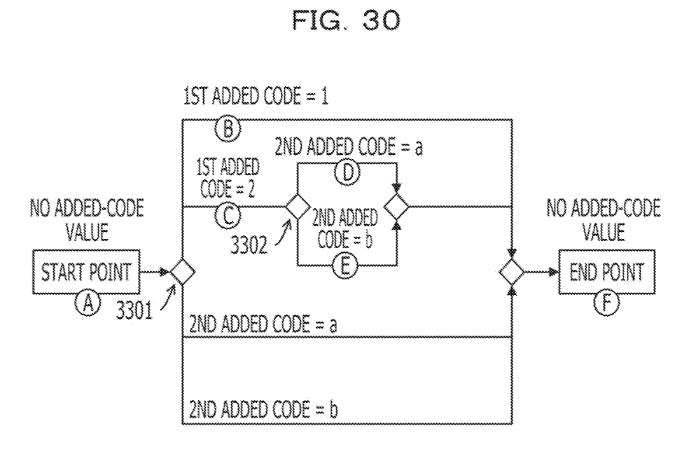

Thereafter, processing is performed on the events D and E whose added-number attribute counts are 2. With respect to the events D and E, the added-number value “first added-number=2” matches the added-number value of the already placed event C. The event C is an event that occurred earlier than the events D and E. Thus, positions after the event C are determined as placement positions of the events D and E. Since the number of branchings on the path from the start point to the placement positions is 1, the branch route with the first added-number=2 is re-branched. More specifically, a second branch point at which the branch route is re-branched into a branch route with the second added-number=a and a branch route with the second added-number=b and a merge point at which the branch routes branched from the second branch point are merged together are added to the branch route with the first added-number=2, thereby performing the re-branching. As illustrated in FIG. 30, the events D and E are placed on the post-rebranching branch routes. In FIG. 30, when the branch route with the first added-number=2 is followed from a first branch point 3301 coupled to the start point, a second branch point 3302 exists. In FIG. 30, the event D is placed on the branch route branched from the second branch point 3302 and having the second added-number=a. The event E is placed on the branch route branched from the second branch point 3302 and having the second added-number=b. The processing up to this point is processing for the first section.

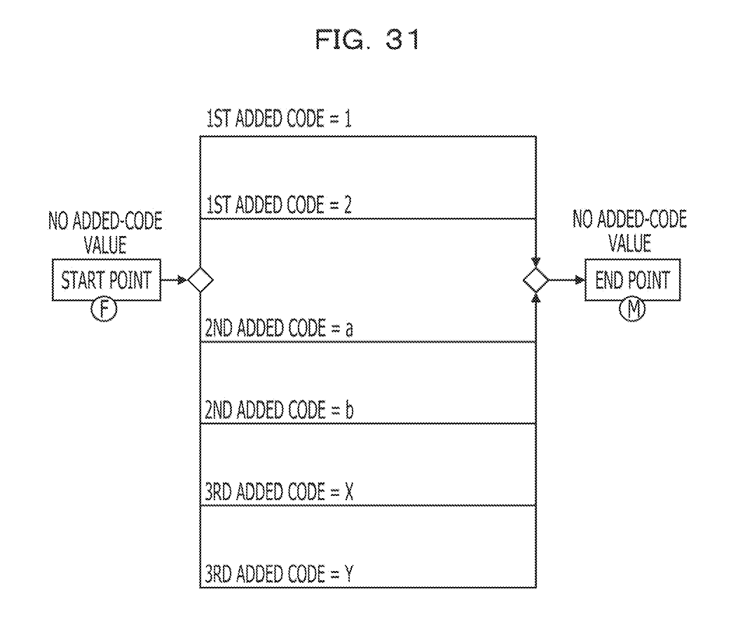

The added-number values set for the events F to M in the second section are the first added-number=1, the first added-number=2, the second added-number=a, the second added-number=b, the third added-number=X, and the third added-number=Y. Thus, when the processing in operation S11 (FIG. 14A) described above is performed on the second section, virtual route data as illustrated in FIG. 31 is generated. In FIG. 31, a first branch point coupled to a start point is branched into a branch route with the first added-number=1, a branch route with the first added-number=2, a branch route with the second added-number=a, a branch route with the second added-number=b, a branch route with the third added-number=X, and a branch route with the third added-number=Y. The event F is placed at the start point and the event M is placed at an end point.

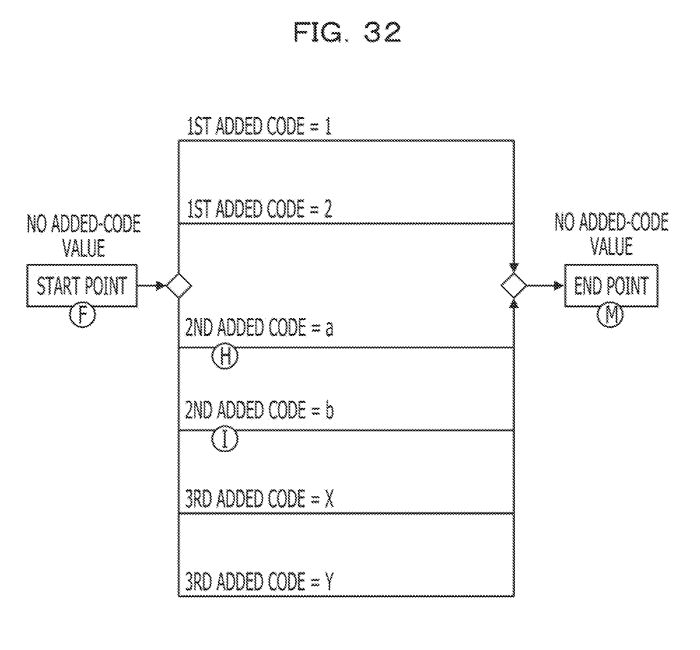

The processing is performed on the events H and I whose added-number attribute counts are 1. Upon completion of the processing, the virtual route data becomes data as illustrated in FIG. 32. In the example of FIG. 32, the event H is placed on the branch route with the second added-number=a and the event I is placed on the branch route with the second added-number=b.

Thereafter, the processing is performed on the events G and L whose added-number attribute counts are 2. In this case, the added-number value “second added-number=a” of the event G matches that of the already placed event H, which is an event that occurred later than the event G. Thus, the event G is temporarily stored in the storage device as an on-hold event. Since an event whose added-number value matches that of the event L does not exist in the already placed events, the event L is also stored in the storage device as an on-hold event.

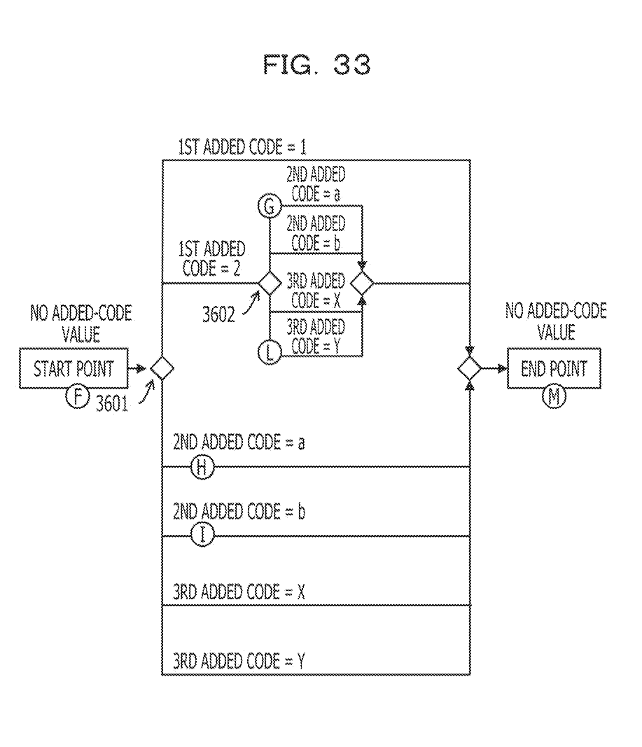

When the series of processing is completed on the events whose added-number attribute counts are 2, the process proceeds to processing for the on-hold events. In this case, since the first added-number=2 is common to the events G and L, it is determined that the events G and L can be placed together on the branch route branched from the first branch point and having the first added-number=2. Since the number of branchings on the path from the start point to the placement positions is 1, the branch route with the first added-number=2 is re-branched. More specifically, a second branch point at which the branch route is re-branched into a branch route with the second added-number=a, a branch route with the second added-number=b, a branch route with the third added-number=X, and a branch route with the third added-number=Y and a merge point at which the branch routes branched from the second branch point are merged together are added to the branch route with the first added-number=2, thereby performing the rebranching. As illustrated in FIG. 33, the events G and L are placed on the post-rebranching branch routes. In FIG. 33, when the branch route with the first added-number=2 is followed from a first branch point 3601 coupled to the start point, a second branch point 3602 exists. In FIG. 33, the event G is placed on the branch route branched from the second branch point 3602 and having the second added-number=a. The event L is placed on the branch route branched from the second branch point 3602 and having the third added-number=Y.

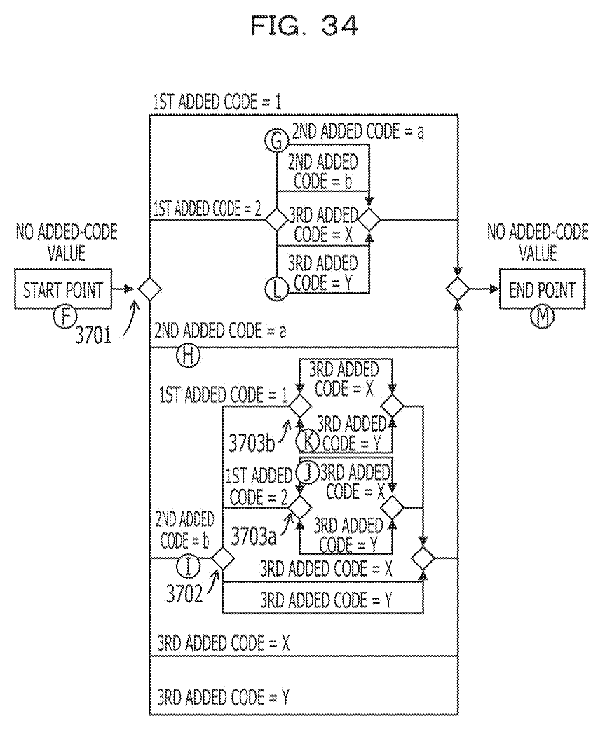

Thereafter, the processing is performed on the events J and K whose added-number attribute counts are 3. In this case, with respect to the event J, an event whose added-number values match two values of those of the event J does not exist in the already placed events. With respect to the event E, although the added-number values match two values of those of the event J, the event E exists in the different section from the event J and thus is not considered in this case. As the events whose added-number value matches one of the added-number values of the added-number values of the event J, the events G and I exist. While both of the events G and I are events that occurred earlier than the event J, the event whose processing time is closer to the event J is the event I. Thus, a position after the event I is determined as the placement position of the event J. Since the number of branchings on the path from the start point to the placement position is 1, the branch route with the second added-number=b is re-branched so that the number of branchings is equal to the added-number attribute count. More specifically, a second branch point at which the branch route is re-branched into a branch route with the first added-number=1, a branch route with the first added-number=2, a branch route with the third added-number=X, and a branch route with the third added-number=Y and a merge point at which the branch routes branched from the second branch point are merged together are added to the branch route with the second added-number=b, thereby performing the rebranching. In addition, the branch route branched from the second branch point and having the first added-number=2 is re-branched. More specifically, a third branch point at which the branch route is re-branched into a branch route with the third added-number=X and a branch route with the third added-number=Y and a merge point at which the branch routes branched from the third branch point are merged together are added to the branch route with the first added-number=2, thereby performing the re-branching. As illustrated in FIG. 34, the event J is placed on the post-rebranching branch route. In FIG. 34, when the branch route with the second added-number=b is followed from a first branch point 3701 coupled to the start point, a second branch point 3702 exists. When a branch route with the first added-number=2 is followed from the second branch point 3702, a third branch point 3703a exists. In FIG. 34, the event J is placed on the branch route branched from the third branch point 3703a and having the third added-number=X.

In this case, with respect to the event K, an event whose added-number values match two values of those of the event K does not exist in the already placed events. As the events whose added-number value matches one of the added-number values of the event K, the events I and L exist. However, since the event L is an event that occurred later than the event K, a position after the event I is determined as the placement position of the event L. Since the event K has a first added-number of 1, the branch route branched from the second branch point 3702 illustrated in FIG. 34 and having the first added-number=1 is re-branched and the event K is placed on a post-rebranching branch route. More specifically, as illustrated in FIG. 34, a third branch point 3703b at which the branch route is re-branched into a branch route with the third added-number=X and a branch route with the third added-number=Y and a merge point at which the branch routes branched from the third branch point 3703b are merged together are added to the branch route with the first added-number=1, thereby performing the re-branching. In FIG. 34, the event K is placed on the branch route branched from the third branch point 3703b and having the third added-number=Y. The processing up to this point is processing for the second section.

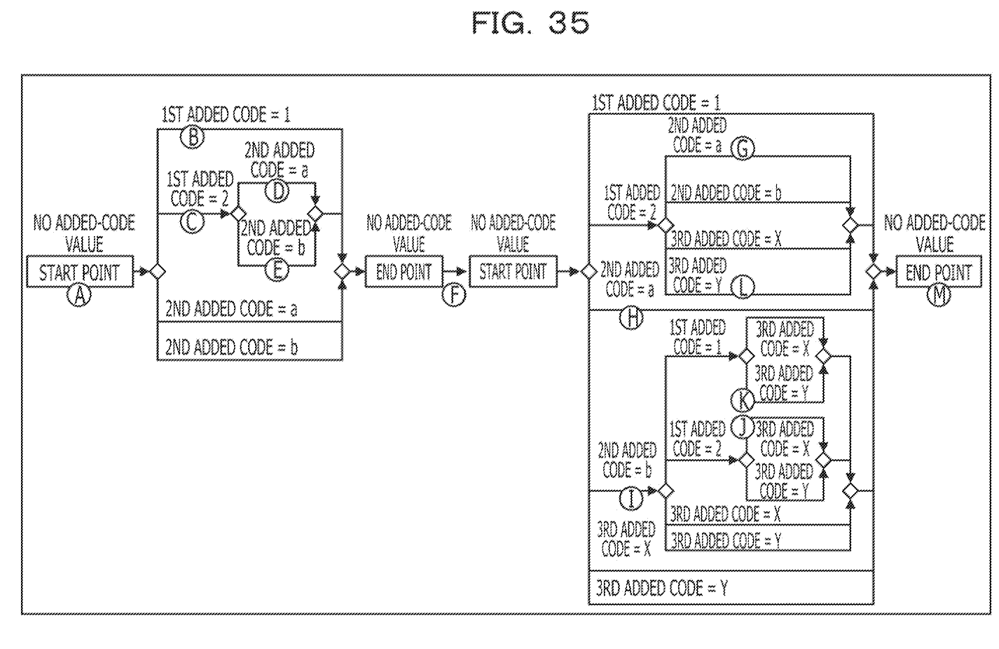

When the virtual route data for the first section (FIG. 30) and the virtual route data for the second section (FIG. 34) are coupled to each other, virtual route data as illustrated in FIG. 35 is obtained. Although the event F is placed at the end point on the virtual route data for the first section and at the start point on the virtual route data for the second section, one of the points is deleted so that only one of which is placed. Thereafter, when a branch route on which no event is placed is deleted from the virtual route data illustrated in FIG. 35 or a branch point and a merge point that continue are integrated into one for organization, data having a task process structure as illustrated in FIG. 27 can be generated eventually.

Thus, according to the scheme of the present embodiment, when the relationships between events executed in parallel and the added-numbers thereof become complicated or even when added-number values are re-used, it is possible to appropriately estimate a task process structure.

Although one embodiment of the present technology has been described above, the present technology is not limited thereto. For example, the functional block of the process-structure estimating apparatus 30 illustrated in FIG. 12 does not necessarily represent an actual program module configuration. Similarly, the structure of the data storage unit is merely one example.

In the processing flows, the order of the processing may also be changed as long as the result of the processing is the same. In addition, the processing may be executed in parallel.

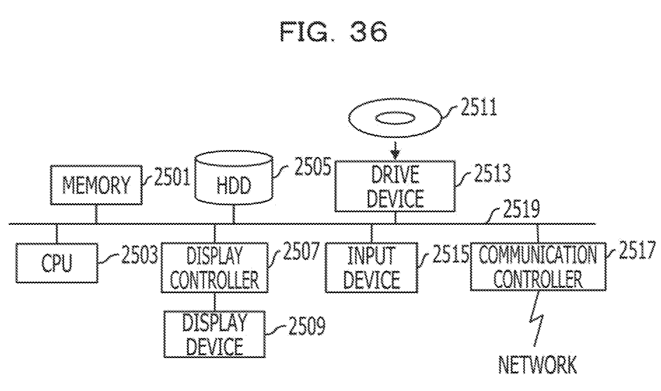

The above-described process-structure estimating apparatus 30 may be a computer apparatus. As illustrated in FIG. 36, the process-structure estimating apparatus 30 may have a configuration in which a memory 2501, a CPU 2503, a hard disk drive (HDD) 2505, a display controller 2507, a drive device 2513 for a removable disk 2511, an input device 2515, and a communication controller 2517 for connection with a network are connected through a bus 2519. A display device 2509 is connected to the display controller 2507. An operating system (OS) and an application program for performing processing in the present embodiment are stored on the HDD 2505. When the OS and the application program are to be executed by the CPU 2503, they are read from the HDD 2505 to the memory 2501. The CPU 2503 controls the display controller 2507, the communication controller 2517, and the drive device 2513 so as to perform desired operations, as needed. Data during processing is also stored in the memory 2501 and, if necessary, is stored on the HDD 2505. In the embodiment of the present technology, the application program for performing the above-described processing is stored on the computable-readable removable disk 2511, is distributed, and is then installed from the drive device 2513 to the HDD 2505. The application program may also be installed on the HDD 2505 via a network, such as the Internet, and the communication controller 2517. In this computer apparatus, hardware, such as the CPU 2503 and the memory 2501, the OS, and the necessary application program cooperate organically with each other to realize various processing as described above.

The above-described embodiments can be summarized as follows.

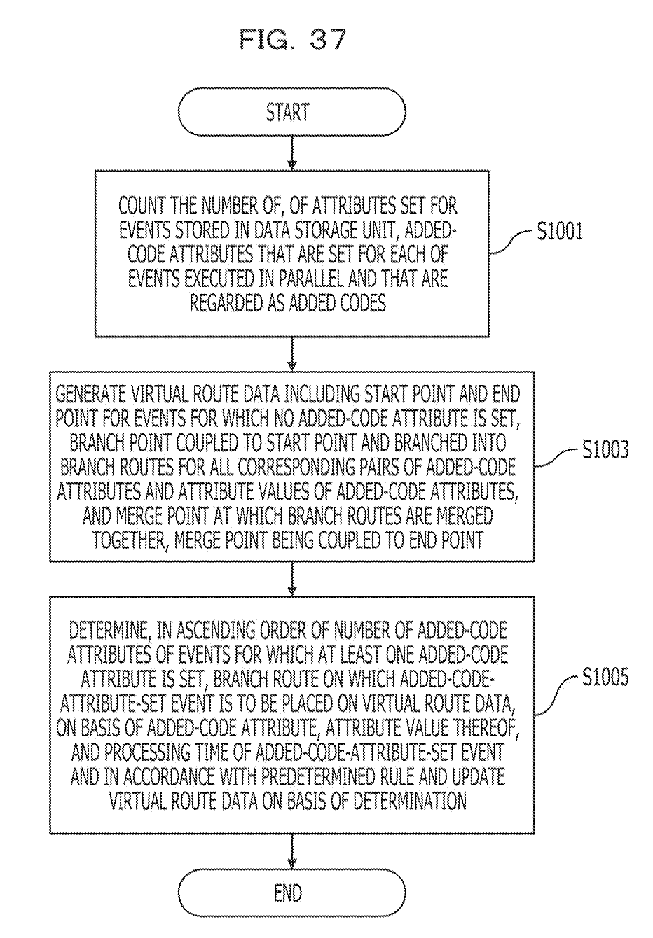

A process-structure estimating method according to a first embodiment includes: an operation (S1001 in FIG. 37) of counting the number of, of attributes set for events executed in a task system and stored in a data storage unit in which processing times and attribute values of the attributes of the events are stored for each event associated with a specific process, added-number attributes that are set for each of the events executed in parallel and that are regarded as added-numbers; a virtual-route-data generating operation (S1003 in FIG. 37) of generating virtual route data including a start point and an end point for the events for which no added-number attribute is set, a branch point coupled to the start point and branched into branch routes for all corresponding pairs of the added-number attributes and the attribute values of the added-number attributes, and a merge point at which the branch routes are merged together, the merge point being coupled to the end point; and an updating operation (S1005 in FIG. 37) of determining, in ascending order of the number of added-number attributes of the events for which the at least one added-number attribute is set, the branch route on which the added-number-attribute-set event is to be placed on the virtual route data, on a basis of the added-number attribute, the attribute value thereof, and the processing time of the added-number-attribute-set event and in accordance with a rule and of updating the virtual route data on a basis of the determination.

With this process-structure estimating method the placements of the events are sequentially determined in ascending order of the number of added-number attributes of the events. Thus, when any event having a smaller number of added-number attributes than an event to be processed exists, the placement of the event to be processed is determined in a state in which the positions of events are sequentially pre-determined in the manner described above. That is, it is possible to determine the placement of the event to be processed, while considering a relative positional relationship with an event having a smaller number of added-number attributes that than the event to be processed. For example, even when the number of branching stages becomes large as a result of repeated rebranching one after another, it is possible to estimate a process structure in accordance with the added-number attributes.

In the first embodiment, the process-structure estimating method may further include, before the above-described virtual-route-data generating operation, an operation of determining whether or not the event for which no added-number attribute is set exists in the events other than the first event and the last event. When the event for which no added-number attribute is set exists in the events other than the first event and the last event, the virtual-route-data generating operation and the subsequent operation may be performed for each of sections sectioned by the event for which no added-number attribute is set and the virtual route data of the sections may be coupled to each other.

For example, when all the branch routes are merged together temporarily and the merged route is then re-branched, there is a possibility that the same added-number attribute is used before and after the merging. In this case, the added-number attribute before the merging and the added-number attribute after the merging need to be processed as having different meanings. Making a determination as to whether any event for which no added-number attribute is set exists except for the first event and the last event makes it possible to determine whether or not all the branch routes are merged together temporarily. When an event for which no added-number attribute is set exists except for the first event and the last event, the processing is executed for each of the sections sectioned by the event. Thus, even when the same added-number attribute is used in multiple sections, it is possible to estimate a process structure, regarding that the added-number attributes in the different sections have different meanings.

The above-described updating operation may include an operation of identifying, when the number of added-number attributes set for the added-number-attribute-set event to be processed is 1, the branch route for the pair of the added-number attribute set for the added-number-attribute-set event to be processed and the attribute value of the added-number attribute and placing a node representing the added-number-attribute-set event to be processed on the identified branch route. With respect to the event having one added-number attribute, the branch route on which the event is to be placed can be uniquely identified based on the added-number attribute and the attribute value of the added-number attribute.

In addition, the above-described updating operation may include: an operation of determining, when the number of added-number attributes set for the added-number-attribute-set event to be processed is two or more, whether or not an associated candidate event that is the added-number-attribute-set event including at least one of the same pairs as the pairs of the added-number attributes set for the added-number-attribute-set event to be processed and the attribute values of the added-number attributes exists in the added-number-attribute-set events whose number of added-number attributes is less than the number of added-number attributes of the added-number-attribute-set event to be processed and whose processing time is earlier than the processing time of the added-number-attribute-set event; an arrangement-placement-position determining operation of identifying, as an associated event, the associated candidate event having a largest number of pairs that are the same as the pairs of the added-number-attribute-set event to be processed, when it is determined that the associated candidate event exists, and of determining, as a placement position of the added-number-attribute-set event to be processed, a position after the identified associated event; an operation of determining whether or not the number of branchings on a path from the start point to the placement position is less than the number of added-number attributes set for the added-number-attribute-set event to be processed, rebranching, when it is determined that the number of branchings is less than the number of added-number attributes set for the added-number-attribute-set event to be processed, the branch route so that the number of branchings is equal to the number of added-number attributes set for the added-number-attribute-set event to be processed, and re-setting the placement position of the added-number-attribute-set event to be processed on a post-rebranching branch route; and an operation of placing a node representing the added-number-attribute-set event to be processed at the placement position. With this arrangement, it is possible to appropriately determine the placement position of an event having two or more added-number attributes. The associated event is an event that is regarded as being executed before the event to be processed.

The placement position determining operation may include an operation of identifying whether or not the added-number-attribute-set event having the added-number attribute and the attribute value of the added-number attribute which are the same as the added-number attribute and the attribute value of the associated event exists and of determining, when the added-number-attribute-set event having the same added-number attribute and attribute value exists, a position between the associated event and the added-number-attribute-set event having the same added-number attribute and attribute value as the placement position of the added-number-attribute-set event to be processed. When the event having the added-number attribute and the attribute value of the added-number attribute which are the same as the added-number attribute and the attribute value of the associated event exists, it can be presumed that the event to be processed occurs between the associated event and the event having the same added-number attribute and attribute value. Thus, it is preferable that the event to be processed be placed between the associated event and the event having the same added-number attribute and attribute value.

In addition, in the placement position determining operation, when the number of associated events is plural, the associated event whose processing time is closest to the processing time of the added-number-attribute-set event to be processed may be preferably determined.

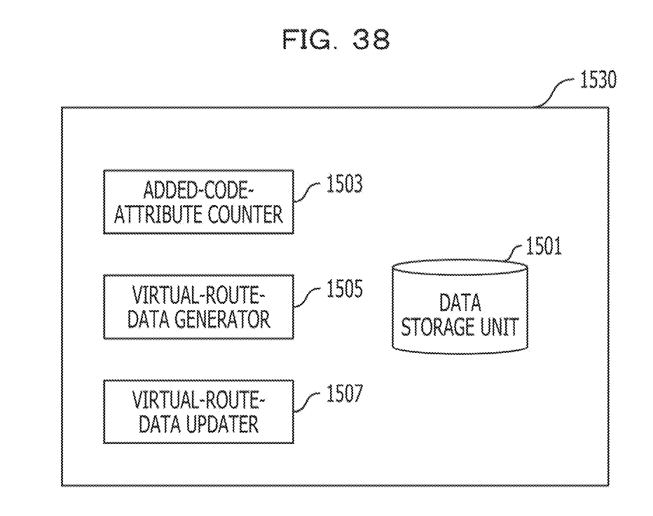

A process-structure estimating apparatus 1530 according to a second embodiment includes a data storage unit (1501 in FIG. 38) that stores processing times and attribute values of attributes of events executed in a task system and associated with specific events; added-number attribute counting unit (an added-number attribute counter 1503 in FIG. 38) for counting the number of the attributes set for the events stored in the data storage unit, added-number attributes that are set for each of the events executed in parallel and that are regarded as added-numbers; virtual-route-data generating unit (a virtual-route-data generator 1505 in FIG. 38) for generating virtual route data including a start point and an end point for the events for which no added-number attribute is set, a branch point coupled to the start point and branched into branch routes for all corresponding pairs of the added-number attributes and the attribute values of the added-number attributes, and a merge point at which the branch routes are merged together, the merge point being coupled to the end point; and virtual-route-data updating unit (a virtual-route-data updater 1507 in FIG. 38) for sequentially determining, in ascending order of the number of added-number attributes of the events for which the at least one added-number attribute is set, the branch route on which the added-number-attribute-set event is to be placed on the virtual route data, on a basis of the added-number attribute, the attribute value thereof, and the processing time of the added-number-attribute-set event and in accordance with a rule and for updating the virtual route data on a basis of the determination.

A program for causing a computer to execute processing as described above may be created and the program may be stored on computer-readable storage media or storage devices, such as a flexible disk, a CD-ROM, a magneto-optical disk, a semiconductor memory, and a hard disk. Data during processing may be temporarily stored on a storage device, such as a memory in the computer.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

1. A process-structure estimating method, comprising:
counting a number of initial attributes that are set for events executed in a task system and added-number attributes that are set for each of the events executed in parallel and are added-numbers;
generating virtual route data including a start point and an end point for the events for which no added-number attribute is set, a branch point coupled to the start point and branched into branch routes for corresponding pairs of the added-number attributes and the attribute values of the added-number attributes, and a merge point at which the branch routes are merged together, the merge point being coupled to the end point;
determining, in ascending order of the number of added-number attributes of the events for which the at least one added-number attribute is set, the branch route on which the added-number-attribute-set event is to be placed on the virtual route data based on the added-number attributes, values thereof, processing times associated therewith, and a rule; and
updating the virtual route data based on the branch route.

2. The process-structure estimating method according to claim 1, further comprising:
determining whether the event for which no added-number attribute is set exists in the events other than a first event and a last event; and
performing, when the event for which no added-number attribute is set exists in the events other than the first event and the last event, the virtual-route-data generation, the branch-route-determination, and virtual-route-data update for each section sectioned by the event for which no added-number attribute is set and coupling the virtual route data generated for each section.

3. The process-structure estimating method according to claim 1, further comprising:
identifying, when the number of added-number attributes set for the added-number-attribute-set event to be processed is one, the branch route for the pair of the added-number attribute set for the added-number-attribute-set event to be processed and the attribute value of the added-number attribute and placing a node representing the added-number-attribute-set event to be processed on the identified branch route.

4. The process-structure estimating method according to claim 1, further comprising:
determining, when the number of added-number attributes set for the added-number-attribute-set event to be processed is two or more, whether an associated candidate event that is the added-number-attribute-set event including at least one of the pairs of the added-number attributes set for the added-number-attribute-set event to be processed and the attribute values of the added-number attributes exists in the added-number-attribute-set events whose number of added-number attributes is less than the number of added-number attributes of the added-number-attribute-set event to be processed and whose processing time is earlier than the processing time of the added-number-attribute-set event;
identifying, as an associated event, the associated candidate event having a largest number of pairs that are the pairs of the added-number-attribute-set event to be processed, when the associated candidate event exists, and determining, as a placement position of the added-number-attribute-set event to be processed, a position after the identified associated event;
determining whether the number of branchings on a path from the start point to the placement position is less than the number of added-number attributes set for the added-number-attribute-set event to be processed, rebranching, when the number of branchings is less than the number of added-number attributes set for the added-number-attribute-set event to be processed, the branch route so that the number of branchings is equal to the number of added-number attributes set for the added-number-attribute-set event to be processed, and re-setting the placement position of the added-number-attribute-set event to be processed on a post-rebranching branch route; and
placing a node representing the added-number-attribute-set event to be processed at the placement position.

5. The process-structure estimating method according to claim 4, further comprising identifying whether the added-number-attribute-set event having the added-number attribute and the attribute value of the added-number attribute which are the same as the added-number attribute and the attribute value of the associated event exists and determining, when the added-number-attribute-set event having the same added-number attribute and attribute value exists, a position between the associated event and the added-number-attribute-set event having the same added-number attribute and attribute value as the placement position of the added-number-attribute-set event to be processed.

6. The process-structure estimating method according to claim 4, further comprising using the associated event whose processing time is closest to that of the added-number-attribute-set event to be processed, when the multiple associated events exist.

7. A non-transitory computer readable recording medium, having recorded thereon a process-structure estimating program causing a computer to perform a process, the process comprising:
counting a number of initial attributes that are set for events executed in a task system and added-number attributes that are set for each of the events executed in parallel and are added-numbers;
generating virtual route data including a start point and an end point for the events for which no added-number attribute is set, a branch point coupled to the start point and branched into branch routes for corresponding pairs of the added-number attributes and the attribute values of the added-number attributes, and a merge point at which the branch routes are merged together, the merge point being coupled to the end point;
determining, in ascending order of the number of added-number attributes of the events for which the at least one added-number attribute is set, the branch route on which the added-number-attribute-set event is to be placed on the virtual route data based on the added-number attributes, values thereof, processing times associated therewith, and a rule and updating the virtual route data based on the branch route.

8. A process-structure estimating apparatus comprising:
a data storage unit that stores processing times and attribute values of attributes of events executed in a task system and associated with specific events;
an added-number attribute counting unit to count the number of initial attributes that are set for the events stored in the data storage unit, and added-number attributes that are set for each of the events executed in parallel and are added-numbers;
a virtual-route-data generating unit to generate virtual route data including a start point and an end point for the events for which no added-number attribute is set, a branch point coupled to the start point and branched into branch routes for corresponding pairs of the added-number attributes and the attribute values of the added-number attributes, and a merge point at which the branch routes are merged together, the merge point being coupled to the end point;
a virtual-route-data updating unit to sequentially determine, in ascending order of the number of added-number attributes of the events for which the at least one added-number attribute is set, the branch route on which the added-number-attribute-set event is to be placed on the virtual route data based on the added-number attributes, values thereof, processing times associated therewith, and a rule and to update the virtual route data based on the branch route.
